(19) United States
(12) Patent Application Publication
(10) Pub. No.: US 2024/0266954 A1
(43) Pub. Date: Aug. 8, 2024

(54) SYSTEMS AND METHODS FOR POWERING UP A CHARGE PUMP

(71) Applicant: pSemi Corporation, San Diego, CA (US)

(72) Inventors: Satish VANGARA, Woodley (GB); Antony Christopher ROUTLEDGE, Basingstoke (GB); Gregory SZCZESZYNSKI, Nashua, NH (US); Alok Kumar MITTAL, Reading (GB)

(73) Assignee: pSemi Corporation, San Diego, CA (US)

(21) Appl. No.: 18/432,641

(22) Filed: Feb. 5, 2024

Related U.S. Application Data
(60) Provisional application No. 63/483,321, filed on Feb. 6, 2023.

(51) Int. Cl. H02M 3/07; H02M 1/088

(52) U.S. Cl. CPC H02M 3/07; H02M 1/088

(57) ABSTRACT

Disclosed are apparatuses and methods for powering up a step-up charge pump circuit. One method embodiment comprises: providing an input voltage at a step-up converter input terminal, without operating the charge pump circuit's phase or series switches; determining that the supply voltages for a first set of voltage regulators are sufficient to operate the phase switches in at least a reduced gate drive mode; after this determination, operating the phase switches without operating the series switches; determining that the supply voltage for one of a second set of voltage regulators is sufficient to operate its corresponding series switch in at least a reduced gate drive mode; and operating the corresponding series switch, after determining that the supply voltage for the one of the second set of voltage regulators is sufficient to operate the corresponding series switch.

### PRIORITY CLAIM

This application claims the benefit of priority to U.S. Provisional Application No. 63/483,321, filed on Feb. 6, 2023, the entire contents of which are incorporated herein by reference for all purposes.

### TECHNICAL FIELD

The present disclosure relates to charge pumps, and more particularly, to apparatuses, integrated circuits, and methods for powering up a step-up charge pump circuit.

### BACKGROUND

Many electronic products, particularly mobile computing and/or communication products and components (e.g., notebook computers, ultra-book computers, tablet devices, LCD and LED displays), require multiple voltage levels. For example, power amplifiers for radio frequency transmitters may require relatively high voltages (e.g., 12 volts (V) or more), and logic circuitry may require a low voltage level (e.g., 1-2 V). Some other circuits may require an intermediate voltage level (e.g., 5-10 V). Various configurations of switched capacitor power conversion circuits, sometimes also known as “charge pumps,” provide voltage conversion (i.e., step up, step down, or bidirectional) between a high side voltage and a low side voltage through controlled transfers of charge between capacitors in the circuit.

### SUMMARY

Embodiments of the present disclosure may provide methods, apparatuses, integrated circuits, and circuit boards for powering up a step-up charge pump circuit. In one embodiment, a method is disclosed for powering up a charge pump circuit operating as a dc-dc step-up converter. The charge pump circuit comprises a plurality of series switches, each series switch including a gate terminal, a drain terminal, and a source terminal; a plurality of phase switches, each series switch including a gate terminal, a drain terminal, and a source terminal; a plurality of fly capacitors, each fly capacitor including a series-side terminal coupled to the source terminal or drain terminal of one of the series switches and a phase-side terminal coupled to the source terminal or drain terminal of one of the phase switches, and a plurality of low-dropout voltage regulators associated with each of the series switches and the phase switches, the low-dropout voltage regulators configured to provide supply voltages to level shifter circuits and driver circuits associated with each of the series switches and the phase switches; wherein a supply voltage for each of the low-dropout voltage regulators is based either on a voltage at the series-side terminal of one of the fly capacitors or on an output voltage of the charge pump circuit.

The method comprises supplying an input voltage from a power source to a charge pump circuit; providing an off signal to the gate terminals of the series switches and the gate terminals of the phase switches; pre-charging the fly capacitors via body diodes associated with the series switches; after pre-charging the fly capacitors, providing a switching signal to the gate terminals of the phase switches to operate the phase switches in a reduced gate drive mode while providing the off signal to the gate terminals of the series switches; determining whether a supply voltage of one of the low-dropout regulators exceeds a predetermined threshold voltage; and after the supply voltage of the one of the low-dropout regulators exceeds the predetermined threshold voltage, providing a switching signal to the gate terminals of the series switch associated with the one of the low-dropout regulators to operate that series switch in a reduced gate drive mode.

In one embodiment, a method is disclosed for powering up a charge pump circuit, the charge pump circuit capable of operating as a step-up converter and comprising: a plurality of phase switches and series switches, each of the switches including a gate terminal coupled to a gate driver circuit; a plurality of fly capacitors, each fly capacitor coupled between at least one phase switch and series switch; a first set of voltage regulators, each configured to drive one of the gate driver circuits coupled to one of the phase switches, and each configured to draw a supply voltage from either a series-side terminal of at least one of the fly capacitors or a step-up converter input terminal; and a second set of voltage regulators, each configured to drive one of the gate driver circuits coupled to one of the series switches, and each configured to draw a supply voltage from either a series-side terminal of at least one of the fly capacitors or a step-up converter output terminal, the method comprising: providing an input voltage at the step-up converter input terminal, without operating the phase switches or the series switches; determining that the supply voltages for the first set of voltage regulators are sufficient to operate the phase switches in at least a reduced gate drive mode; operating the phase switches without operating the series switches, after determining that the supply voltages for the first set of voltage regulators are sufficient to operate the phase switches; determining that the supply voltage for one of the second set of voltage regulators is sufficient to operate its corresponding series switch in at least a reduced gate drive mode; and operating the corresponding series switch, after determining that the supply voltage for the one of the second set of voltage regulators is sufficient to operate the corresponding series switch.

In another embodiment, an integrated circuit is disclosed, comprising: a charge pump circuit capable of operating as a step-up converter and including: a plurality of phase switches and series switches, each of the switches including a gate terminal coupled to a gate driver circuit, wherein the phase switches and series switches are configured to couple to a plurality of fly capacitors, each fly capacitor configured to couple between at least one phase switch and series switch; a first set of voltage regulators, each configured to drive one of the gate driver circuits coupled to one of the phase switches, and each configured to draw a supply voltage from either a series-side terminal of at least one of the fly capacitors or a step-up converter input terminal; and a second set of voltage regulators, each configured to drive one of the gate driver circuits coupled to one of the series switches, and each configured to draw a supply voltage from either a series-side terminal of at least one of the fly capacitors or a step-up converter output terminal; wherein the charge pump circuit is configured to: receive an input voltage at the step-up converter input terminal, without operating the phase switches or the series switches, determine that the supply voltages for the first set of voltage regulators are sufficient to operate the phase switches in at least a reduced gate drive mode, operate the phase switches, without operating the series switches, after determining that the supply voltages for the first set of voltage regulators are sufficient to operate the phase switches, determine that the supply voltage for one of the second set of voltage regulators is sufficient to operate its corresponding series switch in at least a reduced gate drive mode, and operate the corresponding series switch, after determining that the supply voltage for the one of the second set of voltage regulators is sufficient to operate the corresponding series switch.

In yet another embodiment, a power converter apparatus is disclosed, comprising: a charge pump circuit capable of operating as a step-up converter and including: a plurality of phase switches and series switches, each of the switches including a gate terminal coupled to a gate driver circuit; a plurality of fly capacitors, each fly capacitor coupled between at least one phase switch and series switch; a first set of voltage regulators, each configured to drive one of the gate driver circuits coupled to one of the phase switches, and each configured to draw a supply voltage from either a series-side terminal of at least one of the fly capacitors or a step-up converter input terminal; and a second set of voltage regulators, each configured to drive one of the gate driver circuits coupled to one of the series switches, and each configured to draw a supply voltage from either a series-side terminal of at least one of the fly capacitors or a step-up converter output terminal; wherein the charge pump circuit is configured to: receive an input voltage at the step-up converter input terminal, without operating the phase switches or the series switches, determine that the supply voltages for the first set of voltage regulators are sufficient to operate the phase switches in at least a reduced gate drive mode, operate the phase switches, without operating the series switches, after determining that the supply voltages for the first set of voltage regulators are sufficient to operate the phase switches, determine that the supply voltage for one of the second set of voltage regulators is sufficient to operate its corresponding series switch in at least a reduced gate drive mode, and operate the corresponding series switch, after determining that the supply voltage for the one of the second set of voltage regulators is sufficient to operate the corresponding series switch.

In still another embodiment, a method is disclosed for powering up a charge pump circuit, the charge pump circuit capable of operating as a step-up converter and comprising: a plurality of phase switches and series switches, each of the switches including a gate terminal coupled to a gate driver circuit; a plurality of fly capacitors, each fly capacitor coupled between at least one phase switch and series switch; a first set of voltage regulators, each configured to drive one of the gate driver circuits coupled to one of the phase switches, and each configured to draw a supply voltage from either a series-side terminal of at least one of the fly capacitors or a step-up converter input terminal; and a second set of voltage regulators, each configured to drive one of the gate driver circuits coupled to one of the series switches, and each configured to draw a supply voltage from either a series-side terminal of at least one of the fly capacitors or a step-up converter output terminal, the method comprising: providing an input voltage at the step-up converter input terminal, without operating the phase switches or the series switches; determining that the supply voltages for the first set of voltage regulators are sufficient to operate the phase switches in at least a reduced gate drive mode; operating the phase switches without operating the series switches, after determining that the supply voltages for the first set of voltage regulators are sufficient to operate the phase switches; determining that a voltage at the step-up converter output terminal exceeds a threshold voltage; not operating the phase switches and the series switches for a predetermined period of time, after determining that the voltage at the step-up converter output terminal exceeds the threshold voltage; and after the predetermined period of time, determining that the supply voltages for the second set of voltage regulators are sufficient to operate the series switches in at least a reduced gate drive mode, and operating both the phase switches and the series switches, after determining that the supply voltages for the second set of voltage regulators are sufficient to operate the series switches.

In yet another embodiment, an integrated circuit is disclosed, comprising: a charge pump circuit capable of operating as a step-up converter and including: a plurality of phase switches and series switches, each of the switches including a gate terminal coupled to a gate driver circuit, wherein the phase switches and series switches are configured to couple to a plurality of fly capacitors, each fly capacitor configured to couple between at least one phase switch and series switch; a first set of voltage regulators, each configured to drive one of the gate driver circuits coupled to one of the phase switches, and each configured to draw a supply voltage from either a series-side terminal of at least one of the fly capacitors or a step-up converter input terminal; and a second set of voltage regulators, each configured to drive one of the gate driver circuits coupled to one of the series switches, and each configured to draw a supply voltage from either a series-side terminal of at least one of the fly capacitors or a step-up converter output terminal; wherein the charge pump circuit is configured to: receive an input voltage at the step-up converter input terminal, without operating the phase switches or the series switches; determine that the supply voltages for the first set of voltage regulators are sufficient to operate the phase switches in at least a reduced gate drive mode; operate the phase switches without operating the series switches, after determining that the supply voltages for the first set of voltage regulators are sufficient to operate the phase switches; determine that a voltage at the step-up converter output terminal exceeds a threshold voltage; not operate the phase switches and the series switches for a predetermined period of time, after determining that the voltage at the step-up converter output terminal exceeds the threshold voltage; and after the predetermined period of time, determine that the supply voltages for the second set of voltage regulators are sufficient to operate the series switches in at least a reduced gate drive mode, and operate both the phase switches and the series switches, after determining that the supply voltages for the second set of voltage regulators are sufficient to operate the series switches.

In another embodiment, a power converter apparatus is disclosed, comprising: a charge pump circuit capable of operating as a step-up converter and including: a plurality of phase switches and series switches, each of the switches including a gate terminal coupled to a gate driver circuit; a plurality of fly capacitors, each fly capacitor coupled between at least one phase switch and series switch; a first set of voltage regulators, each configured to drive one of the gate driver circuits coupled to one of the phase switches, and each configured to draw a supply voltage from either a series-side terminal of at least one of the fly capacitors or a step-up converter input terminal; and a second set of voltage regulators, each configured to drive one of the gate driver circuits coupled to one of the series switches, and each configured to draw a supply voltage from either a series-side terminal of at least one of the fly capacitors or a step-up converter output terminal; wherein the charge pump circuit is configured to: receive an input voltage at the step-up converter input terminal, without operating the phase switches or the series switches; determine that the supply voltages for the first set of voltage regulators are sufficient to operate the phase switches in at least a reduced gate drive mode; operate the phase switches without operating the series switches, after determining that the supply voltages for the first set of voltage regulators are sufficient to operate the phase switches; determine that a voltage at the step-up converter output terminal exceeds a threshold voltage; not operate the phase switches and the series switches for a predetermined period of time, after determining that the voltage at the step-up converter output terminal exceeds the threshold voltage; and after the predetermined period of time, determine that the supply voltages for the second set of voltage regulators are sufficient to operate the series switches in at least a reduced gate drive mode, and operate both the phase switches and the series switches, after determining that the supply voltages for the second set of voltage regulators are sufficient to operate the series switches.

It is to be understood that the foregoing general description and the following detailed description are exemplary and explanatory only, and are not restrictive of the invention, as claimed.

### BRIEF DESCRIPTION OF THE DRAWINGS

FIG. 1A is a block diagram of an exemplary charge pump circuit 100, consistent with disclosed embodiments.

FIG. 1B is a circuit diagram of an exemplary charge pump circuit 100, consistent with disclosed embodiments.

FIGS. 1C and 1D are circuit diagrams illustrating further exemplary aspects of charge pump circuit 100, consistent with disclosed embodiments.

FIG. 2 is a block diagram illustrating an exemplary power-up procedure 200 for charge pump circuit 100 operating as a step-up converter.

FIG. 3 is a circuit timing diagram 300 illustrating aspects of the exemplary power-up procedure for charge pump circuit 100 operating as a step-up converter.

FIG. 4 is a circuit diagram illustrating an exemplary comparator circuit 400, consistent with disclosed embodiments.

FIG. 5 is a block diagram illustrating an exemplary alternative power-up procedure for charge pump circuit 100 operating as a step-up converter.

FIG. 6 is a circuit timing diagram illustrating aspects of an exemplary power-up procedure for charge pump circuit 100 operating as a step-up converter.

FIG. 7 is a circuit diagram illustrating exemplary aspects of operating charge pump circuit 100 in reduced gate drive mode, consistent with disclosed embodiments.

FIGS. 8A and 8B are circuit timing diagrams illustrating aspects of an exemplary power-up procedure for charge pump circuit 100 operating as a step-up converter.

FIG. 9 is a circuit diagram illustrating exemplary aspects of operating charge pump circuit 100 in reduced gate drive mode, consistent with disclosed embodiments.

FIG. 10 is a circuit diagram, and FIG. 11 is a related circuit timing diagram, illustrating exemplary advantages of the disclosed power-up procedures for charge pump circuit 100.

### DETAILED DESCRIPTION

The following disclosure provides many different exemplary embodiments, or examples, for implementing different features of the provided subject matter. Specific simplified examples of components and arrangements are described below to explain the present disclosure. These are, of course, merely examples and are not intended to be limiting. Further, certain features may be omitted from some figures and description for clarity, and it is to be understood that different features from different drawings and/or portions of the specification may be combined in a single embodiment, and the present disclosure contemplates all such embodiments that combine different features from the different drawings and/or portions of the specification. In addition, the present disclosure may repeat reference numerals and/or letters in the various examples. This repetition is for the purpose of simplicity and clarity and does not in itself dictate a relationship between the various embodiments and/or configurations discussed.

In power conversion, system designers are presented with different scenarios to start-up a bidirectional power converter. In one embodiment, a bidirectional power converter may detect which source is connected for it to start-up from. For example, the bidirectional power converter can start-up by using the input when the input is the source, and start-up from the output when the output is the source. This may require two different start-up schemes, which may add complexity to the design, and/or increase the overall cost associated with the design. In some embodiments, it may be advantageous to start-up from a battery as the source, for the bidirectional power converter to reduce its design complexity. However, it may not be possible to start-up from the battery if the battery does not have sufficient headroom. In that scenario, it may be beneficial to have a parallel charger such as a low drop-out regulator (LDO) connected to the battery, which can charge the battery to a sufficient headroom (i.e., 3.0 V).

Power converters such as charge pumps can be used as a part of a high efficiency battery charging system that is USB Programmable Power Supply (PPS)-capable. The input to the voltage converter can be delivered from the USB PPS adapter to the mobile device, via the VBUS pin. However, if the USB PPS adapter is not connected to the mobile device, the source input may be missing to the charge pump. It may be beneficial in such an embodiment to start-up from the battery. The following embodiments describe start-up schemes for a bidirectional power converter, including when the battery has sufficient headroom to start-up the power converter and can act as the source.

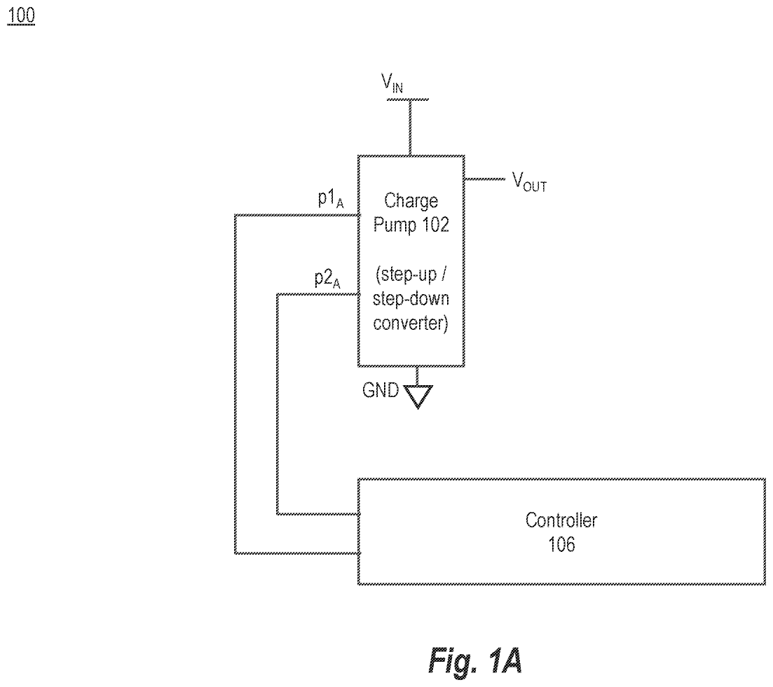

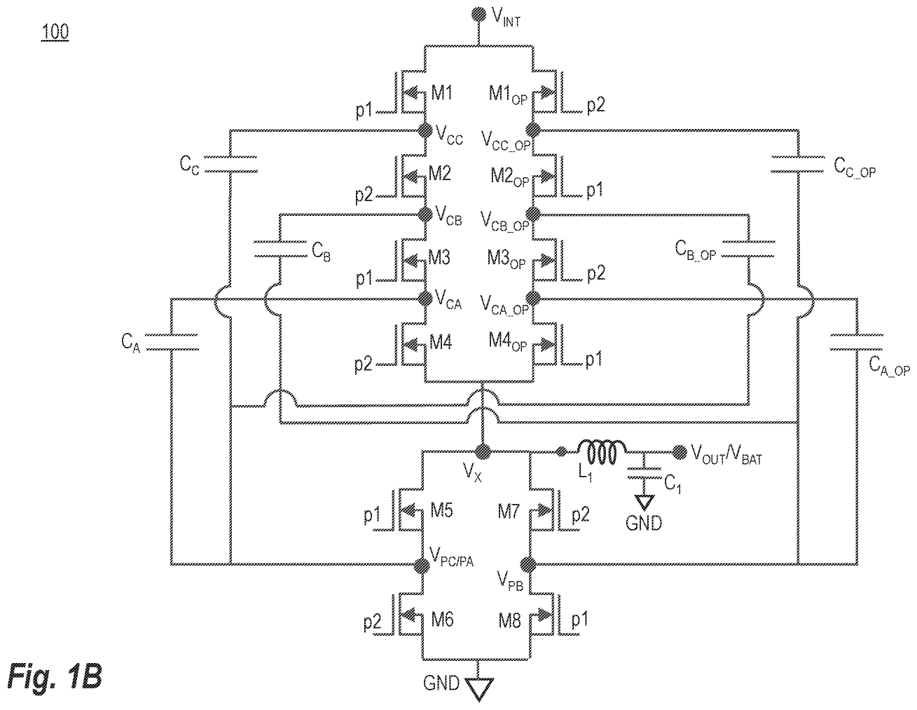

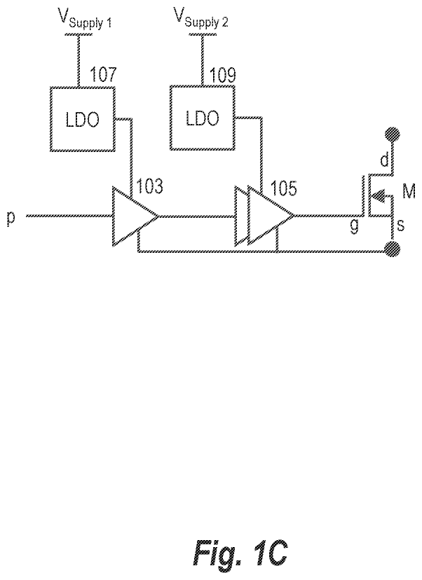

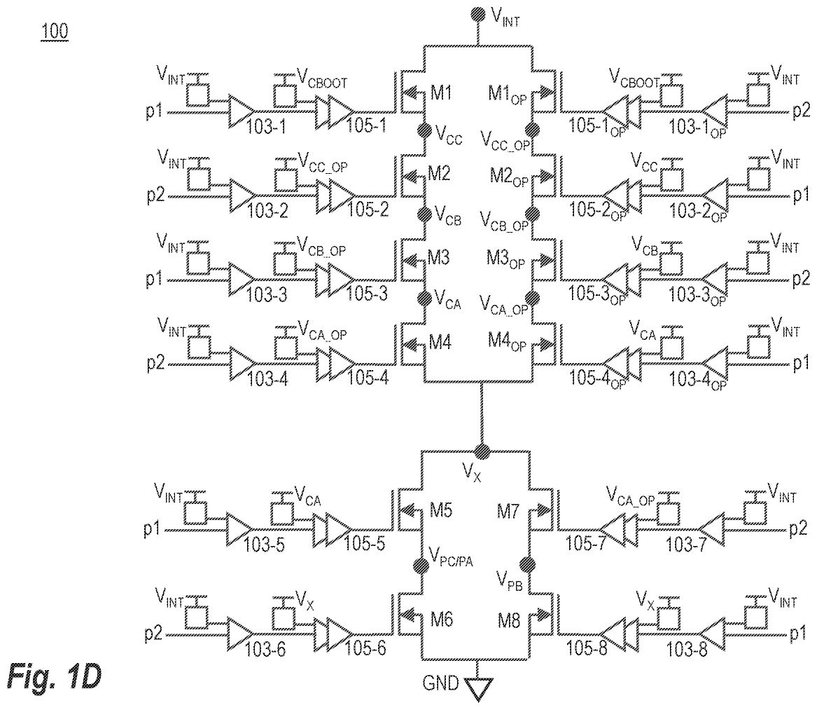

FIG. 1A is a block diagram of an exemplary charge pump circuit 100, consistent with disclosed embodiments. Charge pump circuit 100 may provide voltage conversion (i.e., step up, step down, or bidirectional) between a high-side voltage V_{IN} and a low-side voltage V_{OUT} through controlled transfers of charge between capacitors in the circuit. The operation of charge pump 102 may be controlled by controller 106. Controller 106 may provide control signals, e.g., p1 (and/or its complement) and p2 (and/or its complement), to control the charge transfers in charge pump 102.

FIG. 1B is a circuit diagram of an exemplary charge pump circuit 100, consistent with disclosed embodiments. As shown in FIG. 1B, the charge pump circuit 100 may include series switches M1, M2, M3, and M4, and M1_{OP}, M2_{OP}, M3_{OP}, and M4_{OP}. The term “op” may be referred to as “opposite phase”. Charge pump circuit 100 may further include high-side phase switches M5 and M7, and low-side phase switches M6 and M8. Although the switches M1-M4, M1_{OP}-M4_{OP}, and M5-M8 are depicted as N-channel enhancement type MOSFETs, it is to be understood that any other type of MOSFET, and indeed any other type of known switching device, may be used. The switched capacitor circuit may also include fly capacitors C_{A}, C_{B}, and C_{C}, and C_{A_OP}, C_{B_OP}, and C_{C_OP}. As shown in FIG. 1B, a voltage at a series-side terminal of the fly capacitors C_{A}, C_{B}, and C_{C} may be V_{CA}, V_{CB}, and V_{CC} respectively. Similarly, a voltage at a series-side terminal of the fly capacitors C_{A_OP}, C_{B_OP}, and C_{C_OP} may be V_{CA_OP}, V_{CB_OP}, and V_{CC_OP} respectively. A voltage of a phase-side terminal of the fly capacitors C_{A}, C_{C}, C_{A_OP}, and C_{C_OP} may be V_{PC/PA}, and a voltage of a phase-side terminal of the fly capacitors C_{B} and C_{B_OP} may be V_{PB}. Controller 106 (not shown in FIG. 1B) may provide control signals, e.g., p1 (and/or its complement) and p2 (and/or its complement), to control the switching devices M1-M8 and thus control the transfers of charge between capacitors C_{A}, CB, and CC, and C_{A_OP}, C_{B_OP}, and C_{C_OP}. When operated as a step-down converter, the switched capacitor circuit may step down input voltage V_{INT} to voltage V_{X}, which may be provided through the inductance L₁ and capacitance C₁ as output voltage V_{OUT} of the charge pump.

FIGS. 1C and 1D are circuit diagrams illustrating further exemplary aspects of charge pump circuit 100, consistent with disclosed embodiments. With reference to FIG. 1C, in some embodiments, the gate terminal of a switch M (e.g., switches M1-M8) in the charge pump circuit 100 may be driven using a level shifter circuit 103 and a gate driver circuit 105. As shown in FIG. 1C, in some embodiments, the level shifter circuit 103 and gate driver circuit 105 for a switching device M may be driven using separate low drop-out voltage regulators (LDOs) 107 and 109 respectively, which may be powered using a separate supply voltages V_{Supply1} and V_{Supply2} respectively. A reason for using separate LDOs with separate supply voltages for the level shifter circuit 103 and the gate driver circuit 105 is that level shifter circuits may typically be sensitive to supply voltage fluctuations, which in this case may be caused by transients in the gate voltages if the level shifter circuit 103 and the gate driver circuit 105 share an LDO with a single supply voltage. In general, an external input voltage to the charge pump circuit 100, such as V_{INT} (from an external power supply) or V_{BAT} (from an external battery), may be chosen as the supply voltage for an LDO powering the sensitive level shifter circuit 103, whereas a fluctuating intermediate voltage within the charge pump circuit 100, such as V_{CA}, V_{CB}, V_{CC}, V_{CA_OP}, V_{CB_OP}, V_{CC_OP}, or V_{X} may be employed as a supply voltage for the LDO powering the gate driver circuit 105.

In cases where an N-channel MOSFET is employed as switching device M, and for similar switching devices, the gate voltage is typically required to be greater than the source voltage in order to activate the switching device. Further, the supply voltages V_{Supply1} and V_{Supply2} to the LDOs 107 and 109 are typically required to exceed the required gate voltage by at least the minimum headroom (drop-out voltage) required by the LDOs 107 and 109. Accordingly, the supply voltages V_{Supply1} and V_{Supply2} to the LDOs 107 and 109 are typically required to exceed the source voltage at the switching device M, e.g., at least the Vgs of the device M plus the drop-out voltages of the LDOs 107 and 109. Supply voltages for the different LDOs in charge pump circuit 100 in compliance with these requirements can be drawn from different portions of the charge pump circuit 100 itself, as shown in FIG. 1D. For example, in some embodiments, when operating the charge pump circuit 100 as a step-down converter, the supply voltage V_{Supply1} and V_{Supply2} for each of the level shifter circuits and gate driver circuits can be configured as shown in FIG. 1D and listed in the table below. In FIG. 1D and Table 1, V_{CBOOT} may refer to a voltage that has been bootstrapped above V_{INT}, e.g., V_{INT}+5V, using a bootstrapping capacitor/circuit (not shown in FIG. 1D).

TABLE 1
Input Supplies for Level Shifter and Driver

| | Input Supply for | Input Supply for |
|---|---|---|
| | Level Shifter LDO | Gate Driver LDO |
| M1/M1_{OP} | V_{INT} | V_{CBOOT} |
| M2/M2_{OP} | V_{INT} | V_{CC}_{_{—}}_{OP}/V_{CC} |
| M3/M3_{OP} | V_{INT} | V_{CB}_{_{—}}_{OP}/V_{CB} |
| M4/M4_{OP} | V_{INT} | V_{CA}_{_{—}}_{OP}/V_{CA} |
| M5 | V_{INT} | V_{CA}/V_{CA}_{_{—}}_{OP} |
| M6 | V_{INT} | V_{X} |
| M7 | V_{INT} | V_{CA}_{_{—}}_{OP}/V_{CA} |
| M8 | V_{INT} | V_{X} |

With reference to FIG. 1B, when attempting to operate the charge pump circuit 100 as a step-up converter, the V_{OUT} terminal of FIG. 1B may instead now serve as an input terminal and may be connected to a battery, being supplied with voltage V_{BAT}, and the V_{INT} terminal of FIG. 1B may instead now serve as an output terminal, providing stepped-up output voltage. The inventors here have recognized, however, that in this scenario the supply voltages and related electrical connections described above may not necessarily satisfy the gate voltage and LDO drop-out headroom requirements at all times, in particular when the charge pump circuit 100 first begins operating the switching devices M1-M8 (including M1, M2, M3, and M4, M1_{OP}, M2_{OP}, M3_{OP}, M4_{OP}, M5, M6, M7, and M8) to build up the charge stored at the fly capacitors C_{A}, C_{A_OP}, C_{B}, C_{B_OP}, C_{C}, and C_{C_OP}. This may be in part due to voltage drop across the body diodes of the MOSFET switching devices M1-M4 and M1_{OP}-M4_{OP} disposed between the input voltage terminal V_{BAT} and the terminal voltages V_{CA}/V_{CA_OP}, V_{CB}/V_{CB_OP}, V_{CC}/V_{CC_OP}, and V_{OUT} from which the supply voltages for the LDOs are drawn or bootstrapped (see FIG. 1D).

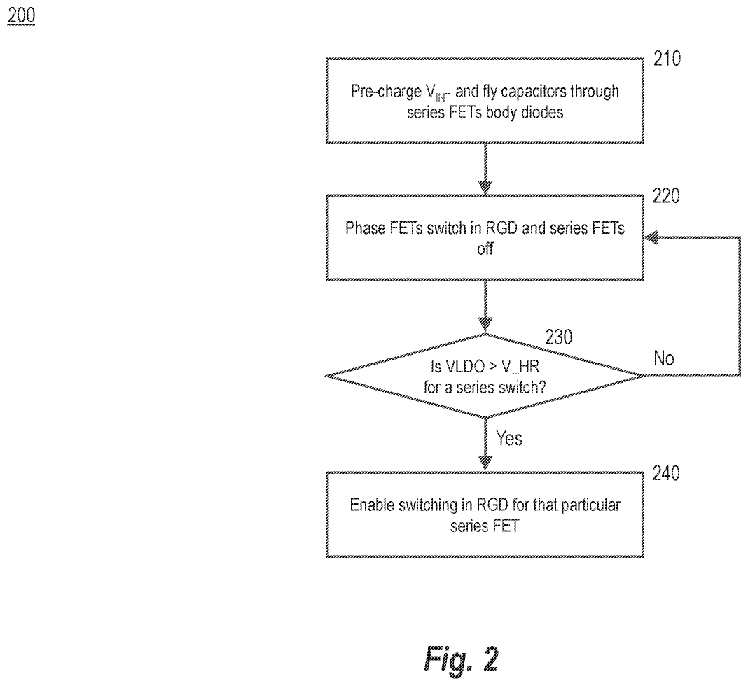

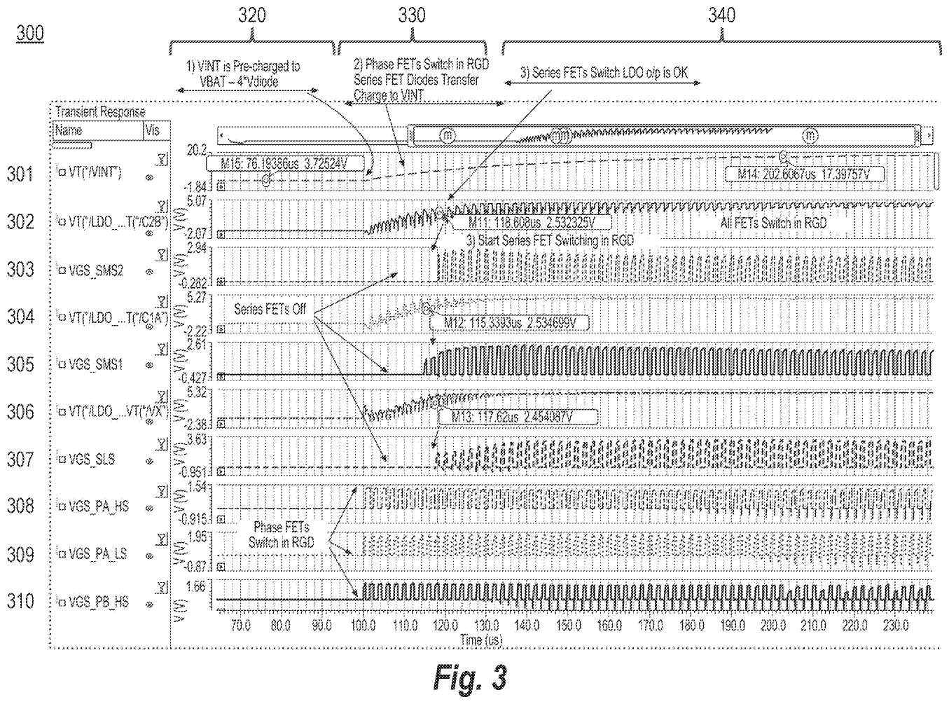

Embodiments of the present disclosure provide methods for powering up the charge pump circuit 100 when operating as a step-up converter in a manner that satisfies the gate voltage and LDO drop-out headroom requirements described above. FIG. 2 is a block diagram illustrating an exemplary power-up procedure 200 for charge pump circuit 100 operating as a step-up converter. And FIG. 3 is a circuit timing diagram 300 illustrating aspects of the exemplary power-up procedure for charge pump circuit 100 operating as a step-up converter. With reference to FIG. 1B, FIG. 2, and FIG. 3, in some embodiments, initially the series switches M1, M2, M3, and M4, and M1_{OP}, M2_{OP}, M3_{OP}, and M4_{OP}, and the phase switches M5-M8 are turned OFF and not operated, because the LDOs powering their respective level shifter circuits and gate driver circuits do not necessarily satisfy the gate voltage and LDO drop-out headroom requirements described above. At FIG. 2, step 210, input voltage supply may be provided at the V_{BAT} terminal (e.g., from a battery source), thus pre-charging the V_{INT} terminal and the fly capacitors C_{A}, C_{A_OP}, C_{B}, C_{B_OP}, C_{C}, and C_{C_OP} through the body diodes of the series switches M1-M4 and M1_{OP}-M4_{OP}. As shown in FIG. 3, during this pre-charging phase 320, the example traces 303, 305, and 307 show that the series switches M1-M4 and M1_{OP}-M4_{OP} may be turned OFF and not operated, and the example traces 308, 309, and 310 show that the phase switches M5-M8 may also be turned OFF and not operated. As example trace 301 shows, V_{INT} may be initially pre-charged to V_{BAT}−4*V_{Diode}, where V_{Diode} is the voltage drop across a body diode of one of the series switches. Similarly, traces 302, 304, and 306 show that the voltages at the series-side terminals of the fly capacitors may be initially pre-charged to V_{BAT}−k*V_{Diode}, where k is the number of series switches disposed between the input terminal V_{BAT} and the series-side terminal of the fly capacitor. The charge pump circuit 100 may be configured to operate in phase 320 for a pre-determined time period.

Phase switches M5-M8 can be placed into (a) an overdriven ON state having low R_{ON} for normal power converter operation, or (2) a reduced drive ON state having a higher R_{ON} selected to provide protection against potentially damaging events (e.g., in-rush or charge transfer current), such as during dynamic re-configuration of the conversion ratio of the power converter, during power converter start-up, when balancing charge among fly capacitors within the power converter, or during fault events such as short circuit events.

At FIG. 2, step 220, switching of the phase switches M5-M8 may be started in reduced gate drive mode because the V_{CA}, V_{CA_OP}, and V_{X} voltages have been built up sufficiently during the pre-charging phase to satisfy the gate voltage and LDO drop-out headroom requirements for operating the phase switches M5-M8 in reduced gate drive mode. For example, start-up and/or operation of any switches in any of the embodiments discussed herein may be performed according to the methods and systems described in U.S. Patent Application Publication No. 2022/0385178 A1 (published Dec. 1, 2022), the entire contents of which are hereby incorporated by reference for all purposes. In reduced gate drive mode, the phase switches M5-M8 may be operating in their respective current saturation regions with a reduced voltage V_{gs} across their respective gate-source junctions (e.g., M5-M8 are N-channel MOSFETs).

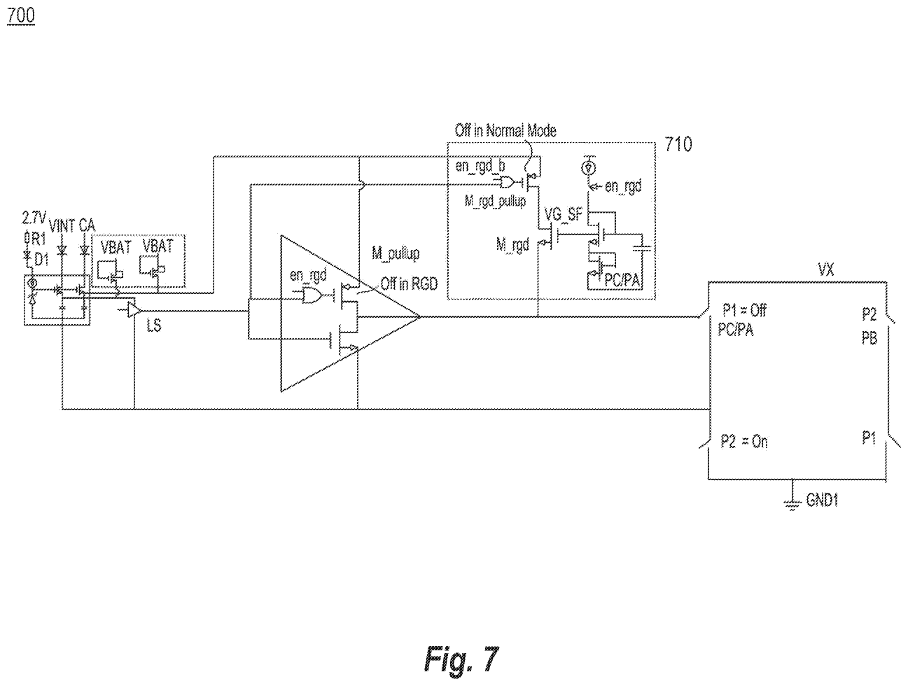

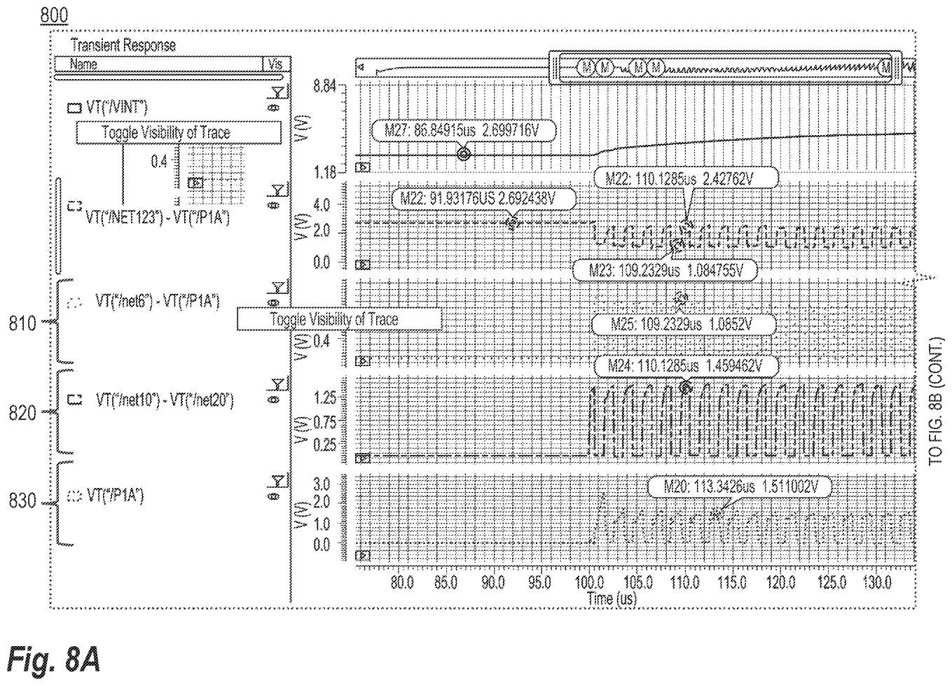

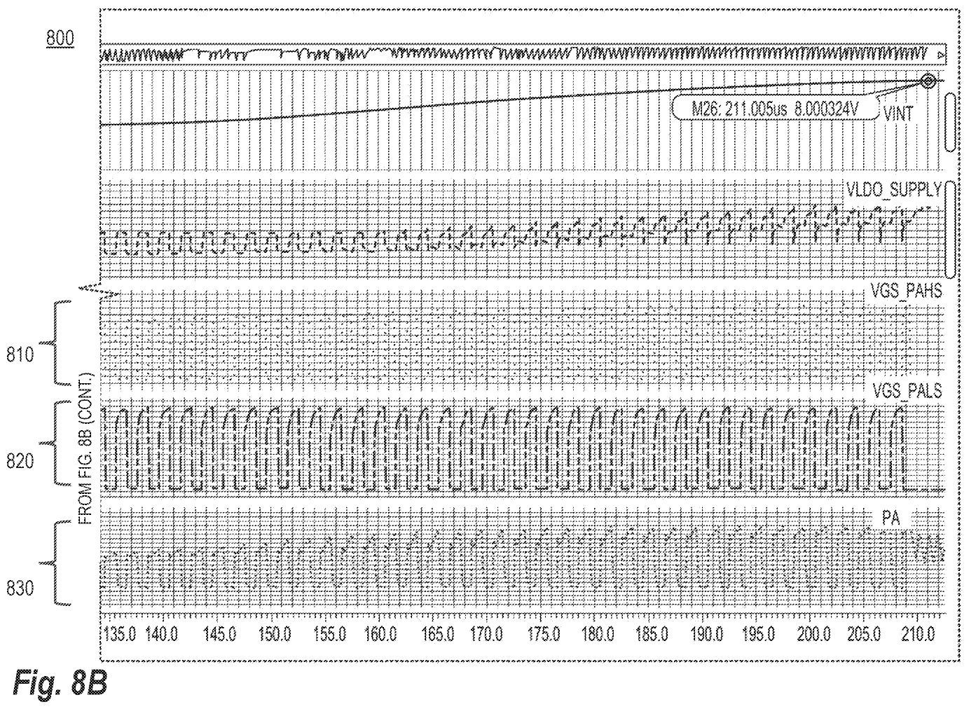

In an alternative embodiment, switching of the phase switches M5-M8 may be started in reduced gate drive mode using V_{BAT} directly, or V_{BAT} in any combination (e.g., OR function) with V_{INT}, V_{CA}, V_{CA_OP}, V_{CB}, V_{CB_OP}, V_{CC}, or V_{CC_OP}, to achieve the gate voltage and LDO drop-out headroom requirements. In such embodiments, a separate gate driver circuit with reduced gate driver capability 710 as shown in FIG. 7 may be provided to operate the phase switches M5-M8 in reduced gate drive mode using V_{BAT} (alone or in combination with VINT, V_{CA}, V_{CA_OP}, V_{CB}, V_{CB_OP}, V_{CC}, or V_{CC_OP}). As shown in FIGS. 8A-B, although the example gate-source voltage VGS trace 810 for the high-side phase switches M5 and M7, and the example gate-source voltage VGS trace 820 for the low-side phase switches M6 and M8 are reduced (e.g., <2 V swing), switching operation of the switches M5-M8 is achieved, as shown by example trace 830.

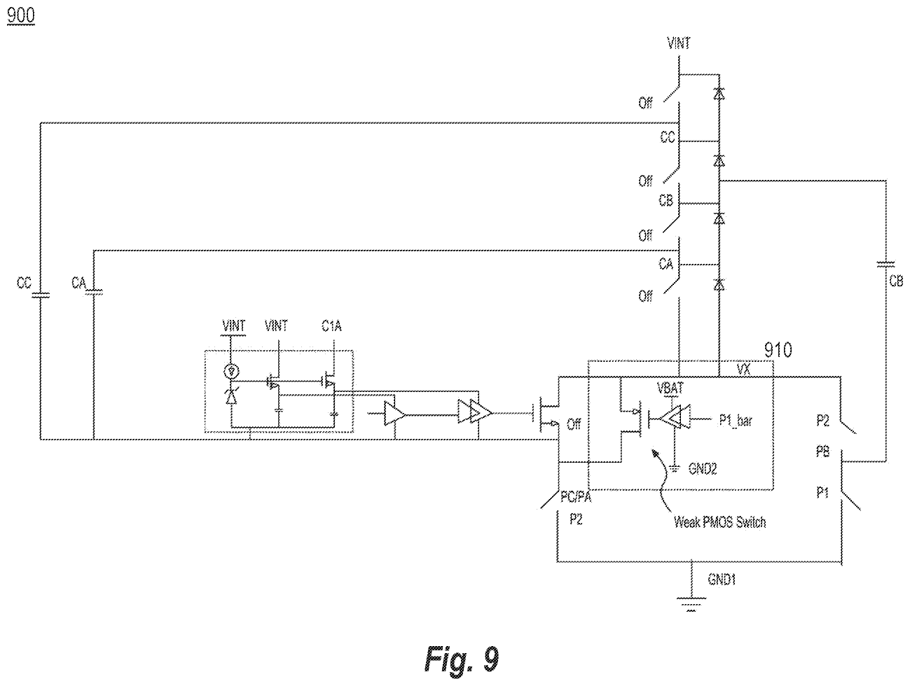

In yet another alternative embodiment, when N-channel MOSFETs are being utilized for phase switches M5-M8, each phase switch M5-M8 may additionally be provided with a P-channel MOSFET electrically coupled in parallel that operates as a weak switch, as shown in FIG. 9, element 910. Such a P-channel MOSFET 910 may not require a bootstrapped voltage, and its switching may be directly started using the V_{BAT} input voltage. Use of the P-channel MOSFET 910 may result in the N-channel MOSFET-based phase switches M5-M8 being bypassed for the purpose of transferring charge from the V_{BAT} input terminal to the fly capacitors during this phase of operation. It is to be understood that the embodiments of FIG. 7 and FIG. 9 may be employed, for example, in situations in which the V_{BAT} input voltage is relatively low.

The series switches M1-M4 and M1_{OP}-M4_{OP} may continue to be turned OFF and not operated in this phase-switch switching state. As shown in FIG. 3, during this phase-switch switching state 330, the example traces 308, 309, and 310 show that switching of the phase switches M5-M8 may be started, and they may be operating in a reduced gate drive mode. The example traces 303, 305, and 307 show that the series switches M1-M4 and M1_{OP}-M4_{OP} may still be turned OFF and not operated at this point in time. As shown by example traces 301, 302, 304, and 306, during this phase 330 the output voltage V_{INT} and the voltages at the series-side terminals of the fly capacitors may continue to build as operation of the phase switches M5-M8 transfers charge from the input voltage terminal V_{BAT} to the fly capacitors C_{A}, C_{A_OP}, C_{B}, C_{B_OP}, C_{C}, and C_{C_OP}.

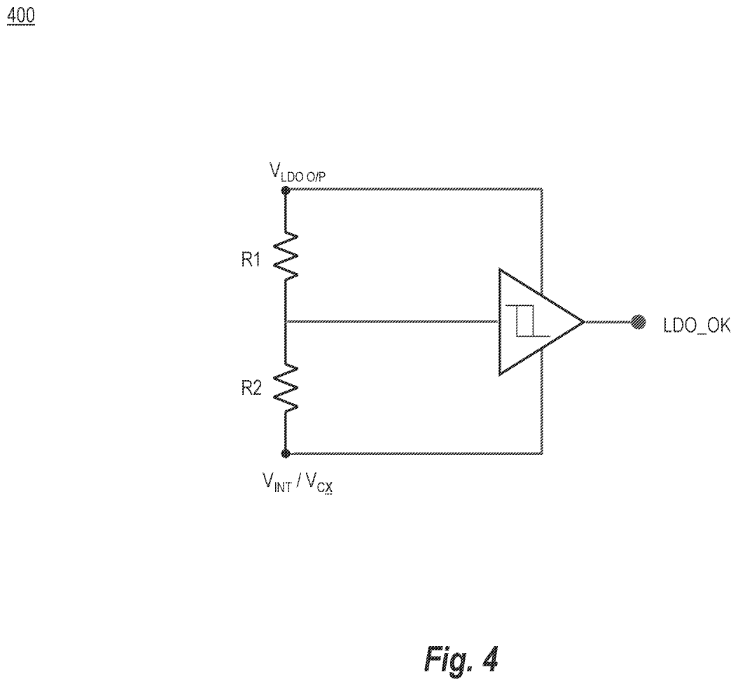

At FIG. 2, step 230, the VINT, V_{CC_OP}, V_{CC}, V_{CB_OP}, V_{CB}, V_{CA_OP}, and V_{CA} voltages (from which the supply voltages for the LDOs for operating the series switches M1-M4 and M1_{OP}-M4_{OP} are drawn or bootstrapped) may be checked to determine whether any of these voltages have been built up sufficiently during the phase-switch switching state to satisfy the gate voltage and LDO drop-out headroom requirements for starting the switching of and operating the series switches M1-M4 and M1_{OP}-M4_{OP} in reduced gate drive mode. For example, as shown in FIG. 4, charge pump circuit 100 may include a comparator circuit 400 to compare a voltage such as VINT, V_{CC_OP}, V_{CC}, V_{CB_OP}, V_{CB}, V_{CA_OP}, and V_{CA} with a threshold voltage V_{LDO} o/P to determine whether their corresponding series switches M1-M4 or M1_{OP}-M4_{OP} (see Table 1 above) can be started to switch and operated in reduced gate drive mode. If any of the V_{INT}, V_{CC_OP}, V_{CC}, V_{CB_OP}, V_{CB}, V_{CA_OP}, or V_{CA} voltages have been built up sufficiently during the phase-switch switching state to satisfy the gate voltage and LDO drop-out headroom requirements for operating the corresponding series switches M1-M4 or M1_{OP}-M4_{OP} in reduced gate drive mode, at FIG. 2, step 240, the corresponding series switch(es) M1-M4 or M1_{OP}-M4_{OP} may be started to switch and operated in a reduced gate drive mode. This process may be repeated until all series switches M1-M4 and M1_{OP}-M4_{OP} have been started to switch and are operating in reduced gate drive mode. In some embodiments, the use of comparator circuits such as comparator circuit 400 in this manner may allow for multiple checkpoints before the series switches M1-M4 or M1_{OP}-M4_{OP} are started to switch and operated (e.g., in a reduced gate drive mode).

As shown in FIG. 3, during the phase-switch switching state 330, the example traces 301, 302, 304, and 306 show that the output voltage V_{INT} and the voltages at the series-side terminals of the fly capacitors may have increased sufficiently that their corresponding series switches M1-M4 or M1_{OP}-M4_{OP} (see Table 1 above) can be started to switch and operated in reduced gate drive mode. The example traces 303, 305, and 307 show that the series switches M1-M4 and/or M1_{OP}-M4_{OP} thus may be started to switch and operated in reduced gate drive mode. As shown by example traces 301, 302, 304, and 306, during this phase 330 the output voltage V_{INT} and the voltages at the series-side terminals of the fly capacitors may continue to build as operation of the phase switches M5-M8 and the turned-on series switches M1-M4 and/or M1_{OP}-M4_{OP} transfer charge from the input voltage terminal V_{BAT} to the fly capacitors C_{A}, C_{A_OP}, C_{B}, C_{B_OP}, C_{C}, and C_{C_OP}.

As mentioned above, this process may be repeated until all series switches M1-M4 and M1_{OP}-M4_{OP} have been started to switch and are operating in reduced gate drive mode. As shown in FIG. 3, during stable operating phase 304, example traces 308, 309, and 310 show that all phase switches M5-M8 have been started to switch and are operating in reduced gate drive mode. Similarly, example traces 303, 305, and 307 show that all series switches M1-M4 and M1_{OP}-M4_{OP} have been started to switch and are operating in reduced gate drive mode. Subsequently, all series switches M1-M4 and M1_{OP}-M4_{OP} and phase switches M5-M8 may be transitioned from operating in reduced gate drive mode to operating in full gate drive mode.

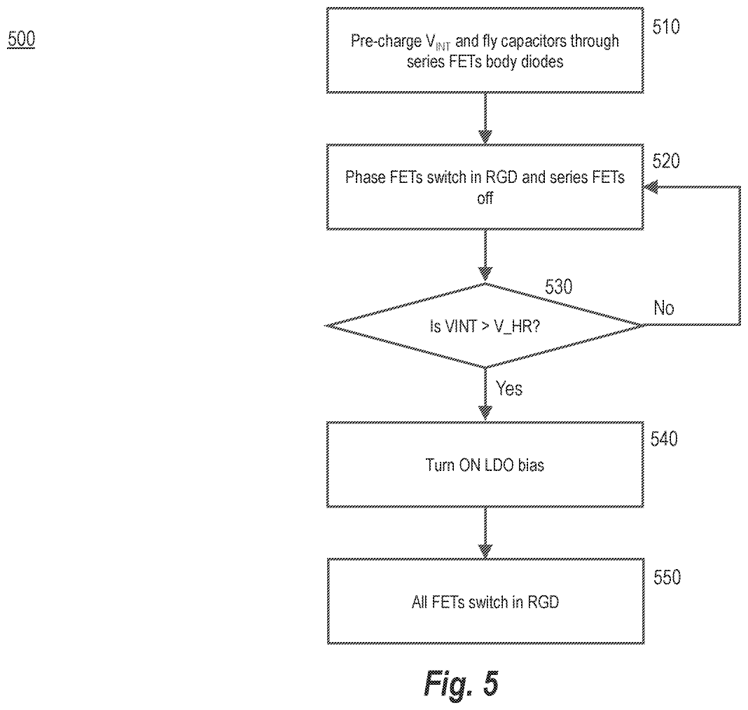

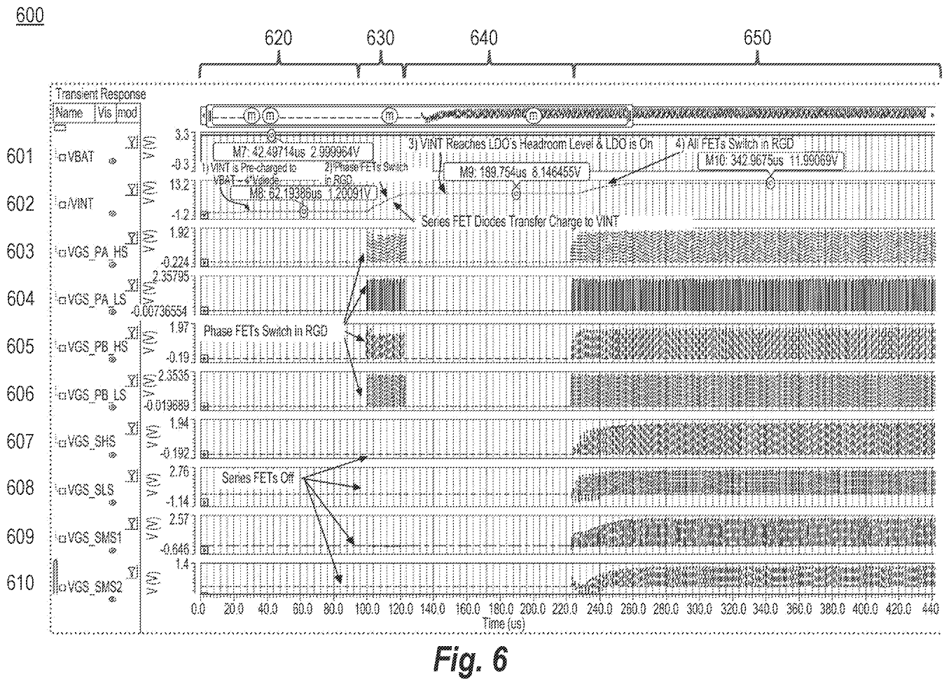

FIG. 5 is a block diagram illustrating an exemplary alternative power-up procedure for charge pump circuit 100 operating as a step-up converter. And FIG. 6 is a circuit timing diagram illustrating aspects of the exemplary alternative power-up procedure for charge pump circuit 100 operating as a step-up converter. With reference to FIG. 1B, FIG. 5, and FIG. 6, in some embodiments, initially the series switches M1, M2, M3, and M4, and M1_{OP}, M2_{OP}, M3_{OP}, and M4_{OP}, and the phase switches M5-M8 are turned OFF and not operated, because the LDOs powering their respective level shifter circuits and gate driver circuits do not necessarily satisfy the gate voltage and LDO drop-out headroom requirements described above. At FIG. 5, step 510, input voltage supply may be provided at the V_{BAT} terminal (e.g., from an external battery source), thus pre-charging the V_{INT} terminal and the fly capacitors C_{A}, C_{A_OP}, C_{B}, C_{B_OP}, C_{C}, and C_{C_OP} through the body diodes of the series switches M1-M4 and M1_{OP}-M4_{OP}. As shown in FIG. 6, during this pre-charging phase 620, example trace 601 shows the input voltage supply provided at the V_{BAT} terminal. The example traces 607, 608, 609, and 610 show that the series switches M1-M4 and M1_{OP}-M4_{OP} may be turned OFF and not operated, and the example traces 603, 604, 605, and 606 show that the phase switches M5-M8 may also be turned OFF and not operated. As example trace 602 shows, V_{INT} may be initially pre-charged to V_{BAT}-4*V_{Diode}, where V_{Diode} is the voltage drop across a body diode of one of the series switches. The charge pump circuit 100 may be configured to operate in phase 620 for a pre-determined time period.

At FIG. 5, step 520, the phase switches M5-M8 may be started to switch and operated in reduced gate drive mode because the V_{CA}, V_{CA_OP}, and V_{X} voltages have been built up sufficiently during the pre-charging phase to satisfy the gate voltage and LDO drop-out headroom requirements for operating the phase switches M5-M8 in reduced gate drive mode. In reduced gate drive mode, the phase switches M5-M8 may be operating in their respective current saturation regions with a reduced voltage V_{gs} across their respective gate-source junctions (e.g., M5-M8 are N-channel MOSFETs).

In an alternative embodiment, the phase switches M5-M8 may be started to switch in reduced gate drive mode using V_{BAT} directly, or V_{BAT} in any combination (e.g., OR function) with V_{INT}, V_{CA}, V_{CA_OP}, V_{CB}, V_{CB_OP}, V_{CC}, or V_{CC_OP}, to achieve the gate voltage and LDO drop-out headroom requirements. In such embodiments, a separate reduced gate driver circuit 710 as shown in FIG. 7 may be provided to operate the phase switches M5-M8 in reduced gate drive mode using V_{BAT} (alone or in combination with VINT, V_{CA}, V_{CA_OP}, V_{CB}, V_{CB_OP}, V_{CC}, or V_{CC_OP}). As shown in FIGS. 8A-B, although the example gate-source voltage VGS trace 810 for the high-side phase switches M5 and M7, and the example gate-source voltage VGS trace 820 for the low-side phase switches M6 and M8 are reduced (e.g., <2 V swing), switching operation of the switches M5-M8 is achieved, as shown by example trace 830.

In yet another alternative embodiment, when N-channel MOSFETs are being utilized for phase switches M5-M8, each phase switch M5-M8 may additionally be provided with a P-channel MOSFET electrically coupled in parallel that operates as a weak switch, as shown in FIG. 9, element 910. Such a P-channel MOSFET 910 may not require a bootstrapped voltage, and its switching may be directly started and it operated using the V_{BAT} input voltage. Use of the P-channel MOSFET 910 may result in the N-channel MOSFET-based phase switches M5-M8 being bypassed for the purpose of transferring charge from the V_{BAT} input terminal to the fly capacitors during this phase of operation.

The series switches M1-M4 and M1_{OP}-M4_{OP} may continue to be turned OFF and not operated in this phase-switch switching state. As shown in FIG. 6, during this phase-switch switching state 630, the example traces 603, 604, 605, and 606 show that phase switches M5-M8 may be started to switch and operated in a reduced gate drive mode. The example traces 607, 608, 609, and 610 show that the series switches M1-M4 and M1_{OP}-M4_{OP} may still be turned OFF and not operated at this point in time. As shown by example trace 602, during this phase 630 the output voltage V_{INT} (and the voltages at the series-side terminals of the fly capacitors) may continue to build as operation of the phase switches M5-M8 transfers charge from the input voltage terminal V_{BAT} to the fly capacitors C_{A}, C_{A_OP}, C_{B}, C_{B_OP}, C_{C}, and C_{C_OP}.

At FIG. 5, step 530, the stepped-up output voltage V_{INT} may be checked to determine whether it has been built up beyond a threshold requirement during the phase switch turn-on phase, e.g., to satisfy certain gate voltage and LDO drop-out headroom requirements for operating the series switches M1-M4 and M1_{OP}-M4_{OP} in reduced gate drive mode. For example, as shown in FIG. 4, charge pump circuit 100 may include a comparator circuit 400 to compare the V_{INT} voltage with a threshold voltage V_{LDO O/P} to determine whether V_{INT} has been sufficiently built up beyond the threshold requirement. If so, at FIG. 5, step 540, the phase switches M5-M8 may be turned OFF and not operated for a predetermined time period, and the LDOs may be turned on and allowed to settle. During this predetermined time period, the series switches M1-M4 and M1_{OP}-M4_{OP} may also still be turned OFF and not operated. For example, the predetermined time period may be provided for V_{INT} to stabilize and to allow the supply voltages to the LDOs and the output voltages from the LDOs to settle. As shown in FIG. 6, during this stabilization phase 640, the example traces 603, 604, 605, and 606 show that phase switches M5-M8 may be turned OFF and not operating. The example traces 607, 608, 609, and 610 show that the series switches M1-M4 and M1_{OP}-M4_{OP} may continue to be turned OFF and not operated at this point in time. As shown by example trace 602, during this phase 640 the output voltage V_{INT} stabilizes as charge transfers from the fly capacitors C_{A}, C_{A_OP}, C_{B}, C_{B_OP}, C_{C}, and C_{C_OP} to the V_{INT} terminal.

After the predetermined time period, at FIG. 5, step 550, all series switches M1-M4 and M1_{OP}-M4_{OP} and phase switches M5-M8 may be started to switch and operated in reduced gate drive mode after the VINT, V_{CC_OP}, V_{CC}, V_{CB_OP}, V_{CB}, V_{CA_OP}, and V_{CA} voltages have been built up sufficiently during the previous phases to satisfy the gate voltage and LDO drop-out headroom requirements. As shown in FIG. 6, during stable operating phase 605, example traces 603, 604, 605, and 606 show that all phase switches M5-M8 have been started to switch and are operating in reduced gate drive mode. Similarly, example traces 607, 608, 609, and 610 show that all series switches M1-M4 and M1_{OP}-M4_{OP} have been started to switch and are operating in reduced gate drive mode. Subsequently, all series switches M1-M4 and M1_{OP}-M4_{OP} and phase switches M5-M8 may be transitioned from operating in reduced gate drive mode to operating in full gate drive mode.

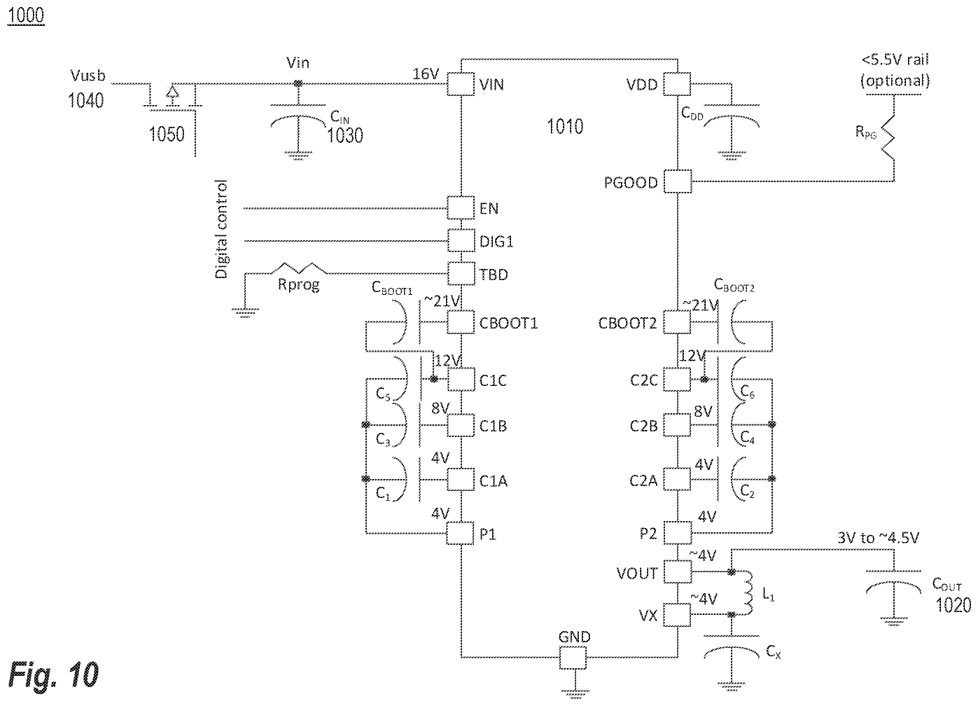

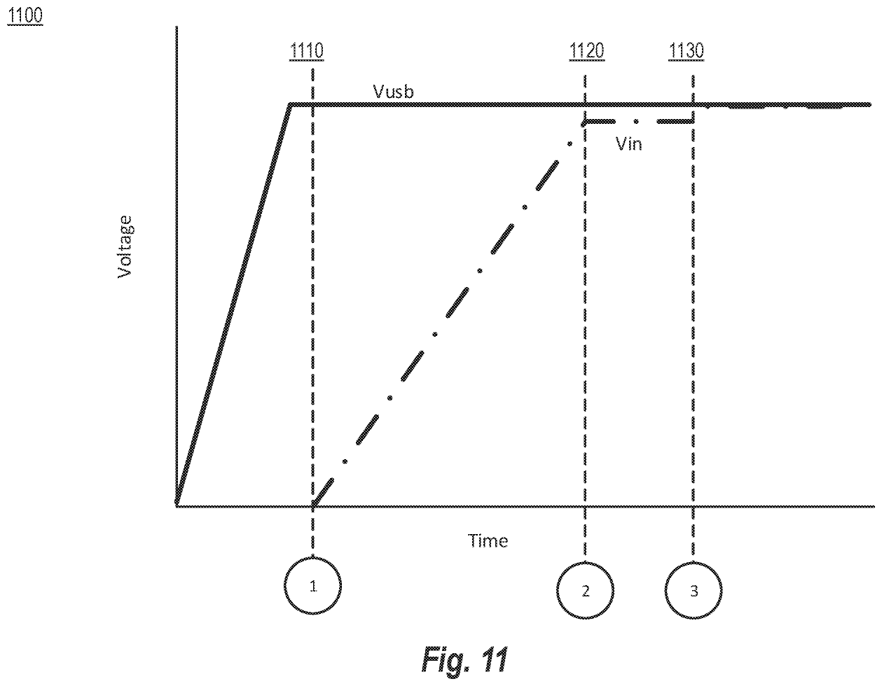

FIG. 10 is a circuit diagram, and FIG. 11 is a related circuit timing diagram, illustrating exemplary advantages of the disclosed power-up procedures for charge pump circuit 100. As shown in FIG. 10, in a system 1000, an integrated-circuit charge pump circuit 1010 may be coupled to a plurality of external fly capacitors, e.g., C₁, C₂, C₃, C₄, C₅, and C₆. Charge pump circuit 1010 may be capable of operating as a step-down converter, e.g., stepping down a voltage at terminal Vin to a voltage VOUT. Charge pump circuit 1010 may also be capable of operating as a step-up converter, e.g., stepping up a voltage at terminal VOUT to a voltage Vin.

Also, charge pump circuit 1010 may be coupled to an internal power source such as a battery of a mobile phone (e.g., C_{OUT} 1020), as well as an external power source (e.g., Vusb 1040). System 1000 may include a disconnect switch 1050 configured to connect or disconnect the external power source Vusb 1040 to or from charge pump circuit 1010. In some scenarios, connecting the external power source Vusb 1040 to charge pump circuit 1010 by turning ON disconnect switch 1050 may lead to an undesirable in-rush current (e.g., capable of damaging components of system 1000 or charge pump circuit 1010, or triggering faults preventing proper operation of system 1000 or charge pump circuit 1010).

Accordingly, in some embodiments, before turning ON disconnect switch 1050 and connecting the external power source Vusb 1040 to charge pump circuit 1010, it may be advantageous to raise the voltage at the terminal Vin so that it is close to or equal to Vusb 1040, so that when disconnect switch 1050 is turned ON, connecting the external power source Vusb 1040 to charge pump circuit 1010, an in-rush current is minimized or eliminated. Doing so may also eliminate the need for an internal boost supply during power-up of the charge pump circuit 1010. Furthermore, during the time that disconnect switch 1050 is turned OFF, the fly capacitors may charge to appropriate ratio(s) of the input voltage while the phase and/or series switches of the charge pump circuit are operating in reduced gate drive mode, as described above.

To accomplish this, as shown in FIG. 11, charge pump circuit 1010 may advantageously initially be operated as a step-up converter, e.g., stepping up a voltage at terminal VOUT (e.g., powered by the battery) to a voltage Vin, thus raising the voltage at the terminal Vin so that it is closer to or equal to Vusb 1040. With reference to FIG. 11, at time 1 (1110), voltage Vin is shown as low compared to Vusb. At this time, connecting the external power source Vusb 1040 to charge pump circuit 1010 by turning ON disconnect switch 1050 may lead to an undesirable in-rush current. However, by advantageously operating charge pump circuit 1010 as a step-up converter, the voltage Vin may be raised so that it is closer to Vusb at time 2 (1120), or equal to Vusb at time 3 (1130). Connecting the external power source Vusb 1040 to charge pump circuit 1010 by turning ON disconnect switch 1050 at these times may lead, by comparison, to minimized or eliminated in-rush current. Subsequently, charge pump circuit 1010 may be operated as a step-down converter, e.g., stepping down a voltage at terminal Vin to a voltage VOUT.

The disclosed embodiments may be further described by the exemplary clauses set forth below:

### Clause Set A1

1. A method for powering up a charge pump circuit,
the charge pump circuit capable of operating as a step-up converter and comprising:
   a plurality of phase switches and series switches, each of the switches including a gate terminal coupled to a gate driver circuit;
   a plurality of fly capacitors, each fly capacitor coupled between at least one phase switch and series switch;
   a first set of voltage regulators, each configured to drive one of the gate driver circuits coupled to one of the phase switches, and each configured to draw a supply voltage from either a series-side terminal of at least one of the fly capacitors or a step-up converter input terminal; and
a second set of voltage regulators, each configured to drive one of the gate driver circuits coupled to one of the series switches, and each configured to draw a supply voltage from either a series-side terminal of at least one of the fly capacitors or a step-up converter output terminal,
the method comprising:
   providing an input voltage at the step-up converter input terminal, without operating the phase switches or the series switches;
   determining that the supply voltages for the first set of voltage regulators are sufficient to operate the phase switches in at least a reduced gate drive mode;
   operating the phase switches without operating the series switches, after determining that the supply voltages for the first set of voltage regulators are sufficient to operate the phase switches;
   determining that the supply voltage for one of the second set of voltage regulators is sufficient to operate its corresponding series switch in at least a reduced gate drive mode; and
   operating the corresponding series switch, after determining that the supply voltage for the one of the second set of voltage regulators is sufficient to operate the corresponding series switch.
      2. The method of clause 1, wherein determining that the supply voltages for the first set of voltage regulators are sufficient to operate the phase switches in at least the reduced gate drive mode comprises:
determining that the supply voltage for one of the first set of voltage regulators exceeds a sum of its drop-out voltage and a source voltage of its associated phase switch.
   3. The method of clause 2, wherein determining that the supply voltage for one of the first set of voltage regulators exceeds the sum of its drop-out voltage and the source voltage of its associated phase switch is performed using a comparator circuit.
   4. The method of any of the preceding clauses, wherein at least one of the first set of voltage regulators is configured to draw its supply voltage via a bootstrapping capacitor or bootstrapping circuit.
   5. The method of clause 4, wherein the at least one of the first set of voltage regulators is configured to draw its supply voltage via the bootstrapping capacitor or the bootstrapping circuit from the step-up converter input terminal.
   6. The method of any of the preceding clauses, wherein operating the phase switches without operating the series switches comprises operating the phase switches in the reduced gate drive mode.
   7. The method of any of the preceding clauses,
wherein the phase switches are N-channel MOSFETs;
wherein the charge pump circuit further comprises a plurality of P-channel MOSFETs, each electrically coupled in parallel with a corresponding N-channel MOSFET phase switch; and
wherein operating the phase switches without operating the series switches comprises operating the P-channel MOSFETs using the supply voltages for the first set of voltage regulators drawn from the step-up converter input terminal.
   8. The method of any of the preceding clauses, wherein determining that the supply voltage for the one of the second set of voltage regulators is sufficient to operate its corresponding series switch in at least the reduced gate drive mode comprises:
determining that the supply voltage for the one of the second set of voltage regulators exceeds a sum of its drop-out voltage and a source voltage of its associated series switch.
   9. The method of clause 8, wherein determining that the supply voltage for the one of the second set of voltage regulators exceeds the sum of its drop-out voltage and the source voltage of its associated series switch is performed using a comparator circuit.
   10. The method of any of the preceding clauses, wherein at least one of the second set of voltage regulators is configured to draw its supply voltage via a bootstrapping capacitor or bootstrapping circuit.
   11. The method of clause 10, wherein the at least one of the second set of voltage regulators is configured to draw its supply voltage via the bootstrapping capacitor or the bootstrapping circuit from the step-up converter output terminal.
   12. The method of any of the preceding clauses, wherein operating the corresponding series switch comprises operating the corresponding series switch in the reduced gate drive mode.
   13. The method of any of the preceding clauses, further comprising:
determining that the supply voltages for a first subset of the second set of voltage regulators are sufficient to operate their corresponding series switches in at least a reduced gate drive mode;
determining that the supply voltages for a second subset of the second set of voltage regulators are insufficient to operate their corresponding series switches in at least a reduced gate drive mode; and
operating the series switches corresponding to the first subset of the second set of voltage regulators while not operating the series switches corresponding to the second subset of the second set of voltage regulators.
   14. The method of any of the preceding clauses, wherein the charge pump circuit is further capable of operating as a step-down converter after it has been powered up.
   15. A charge pump circuit configured to perform the method of any of the preceding clauses.
   16. The charge pump circuit of clause 15, wherein the charge pump circuit is an integrated circuit.
   17. The charge pump circuit of clause 15, wherein the charge pump circuit is an integrated circuit excluding the fly capacitors.

### Clause Set A2

1. An integrated circuit, comprising:
a charge pump circuit capable of operating as a step-up converter and including:
   a plurality of phase switches and series switches, each of the switches including a gate terminal coupled to a gate driver circuit, wherein the phase switches and series switches are configured to couple to a plurality of fly capacitors, each fly capacitor configured to couple between at least one phase switch and series switch;
   a first set of voltage regulators, each configured to drive one of the gate driver circuits coupled to one of the phase switches, and each configured to draw a supply voltage from either a series-side terminal of at least one of the fly capacitors or a step-up converter input terminal; and
   a second set of voltage regulators, each configured to drive one of the gate driver circuits coupled to one of the series switches, and each configured to draw a supply voltage from either a series-side terminal of at least one of the fly capacitors or a step-up converter output terminal;
wherein the charge pump circuit is configured to:
   receive an input voltage at the step-up converter input terminal, without operating the phase switches or the series switches,
   determine that the supply voltages for the first set of voltage regulators are sufficient to operate the phase switches in at least a reduced gate drive mode,
   operate the phase switches, without operating the series switches, after determining that the supply voltages for the first set of voltage regulators are sufficient to operate the phase switches,
   determine that the supply voltage for one of the second set of voltage regulators is sufficient to operate its corresponding series switch in at least a reduced gate drive mode, and
   operate the corresponding series switch, after determining that the supply voltage for the one of the second set of voltage regulators is sufficient to operate the corresponding series switch.
      2. The integrated circuit of clause 1, wherein determining that the supply voltages for the first set of voltage regulators are sufficient to operate the phase switches in at least the reduced gate drive mode comprises:
determining that the supply voltage for one of the first set of voltage regulators exceeds a sum of its drop-out voltage and a source voltage of its associated phase switch.
   3. The integrated circuit of clause 2, further comprising:
a comparator circuit configured to determine whether the supply voltage for one of the first set of voltage regulators exceeds the sum of its drop-out voltage and the source voltage of its associated phase switch.
   4. The integrated circuit of any of the preceding clauses, further comprising:
a bootstrapping capacitor or bootstrapping circuit configured to provide supply voltage to at least one of the first set of voltage regulators.
   5. The integrated circuit of clause 4, wherein the bootstrapping capacitor or the bootstrapping circuit is configured to provide supply voltage to at least one of the first set of voltage regulators from the step-up converter input terminal.
   6. The integrated circuit of any of the preceding clauses, wherein operating the phase switches without operating the series switches comprises operating the phase switches in the reduced gate drive mode.
   7. The integrated circuit of any of the preceding clauses,
wherein the phase switches are N-channel MOSFETs;
wherein the charge pump circuit further includes a plurality of P-channel MOSFETs, each electrically coupled in parallel with a corresponding N-channel MOSFET phase switch; and
wherein operating the phase switches without operating the series switches comprises operating the P-channel MOSFETs using the supply voltages for the first set of voltage regulators drawn from the step-up converter input terminal.
   8. The integrated circuit of any of the preceding clauses, wherein determining that the supply voltage for the one of the second set of voltage regulators is sufficient to operate its corresponding series switch in at least the reduced gate drive mode comprises:
determining that the supply voltage for the one of the second set of voltage regulators exceeds a sum of its drop-out voltage and a source voltage of its associated series switch.
   9. The integrated circuit of clause 8, further comprising:
a comparator circuit configured to determine whether the supply voltage for the one of the second set of voltage regulators exceeds the sum of its drop-out voltage and the source voltage of its associated series switch.
   10. The integrated circuit of any of the preceding clauses, further comprising:
a bootstrapping capacitor or bootstrapping circuit configured to provide supply voltage to at least one of the second set of voltage regulators.
   11. The integrated circuit of clause 10, wherein the bootstrapping capacitor or the bootstrapping circuit is configured to provide supply voltage to at least one of the second set of voltage regulators from the step-up converter output terminal.
   12. The integrated circuit of any of the preceding clauses, wherein operating the corresponding series switch comprises operating the corresponding series switch in the reduced gate drive mode.
   13. The integrated circuit of any of the preceding clauses, wherein the charge pump circuit is further configured to:
determine that the supply voltages for a first subset of the second set of voltage regulators are sufficient to operate their corresponding series switches in at least a reduced gate drive mode;
determine that the supply voltages for a second subset of the second set of voltage regulators are insufficient to operate their corresponding series switches in at least a reduced gate drive mode; and
operate the series switches corresponding to the first subset of the second set of voltage regulators while not operating the series switches corresponding to the second subset of the second set of voltage regulators.
   14. The integrated circuit of any of the preceding clauses, wherein the charge pump circuit is further capable of operating as a step-down converter after it has been powered up.

### Clause Set A3

1. A power converter apparatus, comprising:
a charge pump circuit capable of operating as a step-up converter and including:
   a plurality of phase switches and series switches, each of the switches including a gate terminal coupled to a gate driver circuit;
   a plurality of fly capacitors, each fly capacitor coupled between at least one phase switch and series switch;
   a first set of voltage regulators, each configured to drive one of the gate driver circuits coupled to one of the phase switches, and each configured to draw a supply voltage from either a series-side terminal of at least one of the fly capacitors or a step-up converter input terminal; and
   a second set of voltage regulators, each configured to drive one of the gate driver circuits coupled to one of the series switches, and each configured to draw a supply voltage from either a series-side terminal of at least one of the fly capacitors or a step-up converter output terminal;
wherein the charge pump circuit is configured to:
   receive an input voltage at the step-up converter input terminal, without operating the phase switches or the series switches,
   determine that the supply voltages for the first set of voltage regulators are sufficient to operate the phase switches in at least a reduced gate drive mode,
   operate the phase switches, without operating the series switches, after determining that the supply voltages for the first set of voltage regulators are sufficient to operate the phase switches,
   determine that the supply voltage for one of the second set of voltage regulators is sufficient to operate its corresponding series switch in at least a reduced gate drive mode, and
   operate the corresponding series switch, after determining that the supply voltage for the one of the second set of voltage regulators is sufficient to operate the corresponding series switch.
      2. The apparatus of clause 1, wherein determining that the supply voltages for the first set of voltage regulators are sufficient to operate the phase switches in at least the reduced gate drive mode comprises:
determining that the supply voltage for one of the first set of voltage regulators exceeds a sum of its drop-out voltage and a source voltage of its associated phase switch.
   3. The apparatus of clause 2, further comprising:
a comparator circuit configured to determine whether the supply voltage for one of the first set of voltage regulators exceeds the sum of its drop-out voltage and the source voltage of its associated phase switch.
   4. The apparatus of any of the preceding clauses, further comprising:
a bootstrapping capacitor or bootstrapping circuit configured to provide supply voltage to at least one of the first set of voltage regulators.
   5. The apparatus of clause 4, wherein the bootstrapping capacitor or the bootstrapping circuit is configured to provide supply voltage to at least one of the first set of voltage regulators from the step-up converter input terminal.
   6. The apparatus of any of the preceding clauses, wherein operating the phase switches without operating the series switches comprises operating the phase switches in the reduced gate drive mode.
   7. The apparatus of any of the preceding clauses,
wherein the phase switches are N-channel MOSFETs;
wherein the charge pump circuit further includes a plurality of P-channel MOSFETs, each electrically coupled in parallel with a corresponding N-channel MOSFET phase switch; and
wherein operating the phase switches without operating the series switches comprises operating the P-channel MOSFETs using the supply voltages for the first set of voltage regulators drawn from the step-up converter input terminal.
   8. The apparatus of any of the preceding clauses, wherein determining that the supply voltage for the one of the second set of voltage regulators is sufficient to operate its corresponding series switch in at least the reduced gate drive mode comprises: determining that the supply voltage for the one of the second set of voltage regulators exceeds a sum of its drop-out voltage and a source voltage of its associated series switch.
   9. The apparatus of clause 8, further comprising:
a comparator circuit configured to determine whether the supply voltage for the one of the second set of voltage regulators exceeds the sum of its drop-out voltage and the source voltage of its associated series switch.
   10. The apparatus of any of the preceding clauses, further comprising:
a bootstrapping capacitor or bootstrapping circuit configured to provide supply voltage to at least one of the second set of voltage regulators.
   11. The apparatus of clause 10, wherein the bootstrapping capacitor or the bootstrapping circuit is configured to provide supply voltage to at least one of the second set of voltage regulators from the step-up converter output terminal.
   12. The apparatus of any of the preceding clauses, wherein operating the corresponding series switch comprises operating the corresponding series switch in the reduced gate drive mode.
   13. The apparatus of any of the preceding clauses, wherein the charge pump circuit is further configured to:
determine that the supply voltages for a first subset of the second set of voltage regulators are sufficient to operate their corresponding series switches in at least a reduced gate drive mode;
determine that the supply voltages for a second subset of the second set of voltage regulators are insufficient to operate their corresponding series switches in at least a reduced gate drive mode; and
operate the series switches corresponding to the first subset of the second set of voltage regulators while not operating the series switches corresponding to the second subset of the second set of voltage regulators.
   14. The apparatus of any of the preceding clauses, wherein the charge pump circuit is further capable of operating as a step-down converter after it has been powered up.

### Clause Set B1

1. A method for powering up a charge pump circuit,
the charge pump circuit capable of operating as a step-up converter and comprising:
   a plurality of phase switches and series switches, each of the switches including a gate terminal coupled to a gate driver circuit;
   a plurality of fly capacitors, each fly capacitor coupled between at least one phase switch and series switch;
   a first set of voltage regulators, each configured to drive one of the gate driver circuits coupled to one of the phase switches, and each configured to draw a supply voltage from either a series-side terminal of at least one of the fly capacitors or a step-up converter input terminal; and
   a second set of voltage regulators, each configured to drive one of the gate driver circuits coupled to one of the series switches, and each configured to draw a supply voltage from either a series-side terminal of at least one of the fly capacitors or a step-up converter output terminal,
the method comprising:
   providing an input voltage at the step-up converter input terminal, without operating the phase switches or the series switches;
   determining that the supply voltages for the first set of voltage regulators are sufficient to operate the phase switches in at least a reduced gate drive mode;
   operating the phase switches without operating the series switches, after determining that the supply voltages for the first set of voltage regulators are sufficient to operate the phase switches;
   determining that a voltage at the step-up converter output terminal exceeds a threshold voltage;
   not operating the phase switches and the series switches for a predetermined period of time, after determining that the voltage at the step-up converter output terminal exceeds the threshold voltage; and
   after the predetermined period of time, determining that the supply voltages for the second set of voltage regulators are sufficient to operate the series switches in at least a reduced gate drive mode, and
   operating both the phase switches and the series switches, after determining that the supply voltages for the second set of voltage regulators are sufficient to operate the series switches.
      2. The method of clause 1, wherein determining that the supply voltages for the first set of voltage regulators are sufficient to operate the phase switches in at least the reduced gate drive mode comprises:
determining that the supply voltage for one of the first set of voltage regulators exceeds a sum of its drop-out voltage and a source voltage of its associated phase switch.
   3. The method of clause 2, wherein determining that the supply voltage for one of the first set of voltage regulators exceeds the sum of its drop-out voltage and the source voltage of its associated phase switch is performed using a comparator circuit.
   4. The method of any of the preceding clauses, wherein at least one of the first set of voltage regulators is configured to draw its supply voltage via a bootstrapping capacitor or bootstrapping circuit.
   5. The method of clause 4, wherein the at least one of the first set of voltage regulators is configured to draw its supply voltage via the bootstrapping capacitor or the bootstrapping circuit from the step-up converter input terminal.
   6. The method of any of the preceding clauses, wherein operating the phase switches without operating the series switches comprises operating the phase switches in the reduced gate drive mode.
   7. The method of any of the preceding clauses,
wherein the phase switches are N-channel MOSFETs;
wherein the charge pump circuit further comprises a plurality of P-channel MOSFETs, each electrically coupled in parallel with a corresponding N-channel MOSFET phase switch; and
wherein operating the phase switches without operating the series switches comprises operating the P-channel MOSFETs using the supply voltages for the first set of voltage regulators drawn from the step-up converter input terminal.
   8. The method of any of the preceding clauses, wherein determining that a voltage at the step-up converter output terminal exceeds a threshold voltage is performed using a comparator circuit.
   9. The method of any of the preceding clauses, wherein determining that the supply voltages for the second set of voltage regulators are sufficient to operate the series switches in at least a reduced gate drive mode comprises:
determining that the supply voltage for the one of the second set of voltage regulators exceeds a sum of its drop-out voltage and a source voltage of its associated series switch.
   10. The method of any clause 9, wherein determining that the supply voltage for the one of the second set of voltage regulators exceeds the sum of its drop-out voltage and the source voltage of its associated series switch is performed using a comparator circuit.
   11. The method of any of the preceding clauses, wherein at least one of the second set of voltage regulators is configured to draw its supply voltage via a bootstrapping capacitor or bootstrapping circuit.
   12. The method of clause 11, wherein the at least one of the second set of voltage regulators is configured to draw its supply voltage via the bootstrapping capacitor or the bootstrapping circuit from the step-up converter output terminal.
   13. The method of any of the preceding clauses, wherein operating both the phase switches and the series switches comprises operating both the phase switches and the series switches in the reduced gate drive mode.
   14. The method of any of the preceding clauses, wherein the charge pump circuit is further capable of operating as a step-down converter after it has been powered up.
   15. A charge pump circuit configured to perform the method of any of the preceding clauses.
   16. The charge pump circuit of clause 15, wherein the charge pump circuit is an integrated circuit.
   17. The charge pump circuit of clause 15, wherein the charge pump circuit is an integrated circuit excluding the fly capacitors.

### Clause Set B2

1. An integrated circuit, comprising:
a charge pump circuit capable of operating as a step-up converter and including:
   a plurality of phase switches and series switches, each of the switches including a gate terminal coupled to a gate driver circuit, wherein the phase switches and series switches are configured to couple to a plurality of fly capacitors, each fly capacitor configured to couple between at least one phase switch and series switch;
   a first set of voltage regulators, each configured to drive one of the gate driver circuits coupled to one of the phase switches, and each configured to draw a supply voltage from either a series-side terminal of at least one of the fly capacitors or a step-up converter input terminal; and
   a second set of voltage regulators, each configured to drive one of the gate driver circuits coupled to one of the series switches, and each configured to draw a supply voltage from either a series-side terminal of at least one of the fly capacitors or a step-up converter output terminal;
wherein the charge pump circuit is configured to:
   receive an input voltage at the step-up converter input terminal, without operating the phase switches or the series switches;
   determine that the supply voltages for the first set of voltage regulators are sufficient to operate the phase switches in at least a reduced gate drive mode;
   operate the phase switches without operating the series switches, after determining that the supply voltages for the first set of voltage regulators are sufficient to operate the phase switches;
   determine that a voltage at the step-up converter output terminal exceeds a threshold voltage;
   not operate the phase switches and the series switches for a predetermined period of time, after determining that the voltage at the step-up converter output terminal exceeds the threshold voltage; and
   after the predetermined period of time, determine that the supply voltages for the second set of voltage regulators are sufficient to operate the series switches in at least a reduced gate drive mode, and
   operate both the phase switches and the series switches, after determining that the supply voltages for the second set of voltage regulators are sufficient to operate the series switches.
      2. The integrated circuit of clause 1, wherein determining that the supply voltages for the first set of voltage regulators are sufficient to operate the phase switches in at least the reduced gate drive mode comprises:
determining that the supply voltage for one of the first set of voltage regulators exceeds a sum of its drop-out voltage and a source voltage of its associated phase switch.
   3. The integrated circuit of clause 2, further comprising:
a comparator circuit configured to determine whether the supply voltage for one of the first set of voltage regulators exceeds the sum of its drop-out voltage and the source voltage of its associated phase switch.
   4. The integrated circuit of any of the preceding clauses, further comprising:
a bootstrapping capacitor or bootstrapping circuit configured to provide supply voltage to at least one of the first set of voltage regulators.
   5. The integrated circuit of clause 4, wherein the bootstrapping capacitor or the bootstrapping circuit is configured to provide supply voltage to at least one of the first set of voltage regulators from the step-up converter input terminal.
   6. The integrated circuit of any of the preceding clauses, wherein operating the phase switches without operating the series switches comprises operating the phase switches in the reduced gate drive mode.
   7. The integrated circuit of any of the preceding clauses,
wherein the phase switches are N-channel MOSFETs;
wherein the charge pump circuit further comprises a plurality of P-channel MOSFETs, each electrically coupled in parallel with a corresponding N-channel MOSFET phase switch; and
wherein operating the phase switches without operating the series switches comprises operating the P-channel MOSFETs using the supply voltages for the first set of voltage regulators drawn from the step-up converter input terminal.
   8. The integrated circuit of any of the preceding clauses, further comprising:
a comparator circuit configured to determine whether a voltage at the step-up converter output terminal exceeds a threshold voltage.
   9. The integrated circuit of any of the preceding clauses, wherein determining that the supply voltages for the second set of voltage regulators are sufficient to operate the series switches in at least a reduced gate drive mode comprises:
determining that the supply voltage for the one of the second set of voltage regulators exceeds a sum of its drop-out voltage and a source voltage of its associated series switch.
   10. The integrated circuit of any clause 9, further comprising:
a comparator circuit configured to determining whether the supply voltage for the one of the second set of voltage regulators exceeds the sum of its drop-out voltage and the source voltage of its associated series switch.
   11. The integrated circuit of any of the preceding clauses, further comprising:
a bootstrapping capacitor or bootstrapping circuit configured to provide supply voltage to at least one of the second set of voltage regulators.
   12. The integrated circuit of clause 11, wherein the bootstrapping capacitor or the bootstrapping circuit configured to provide supply voltage to at least one of the second set of voltage regulators from the step-up converter output terminal.
   13. The integrated circuit of any of the preceding clauses, wherein operating both the phase switches and the series switches comprises operating both the phase switches and the series switches in the reduced gate drive mode.
   14. The integrated circuit of any of the preceding clauses, wherein the charge pump circuit is further capable of operating as a step-down converter after it has been powered up.

### Clause Set B3

1. A power converter apparatus, comprising:
a charge pump circuit capable of operating as a step-up converter and including:
   a plurality of phase switches and series switches, each of the switches including a gate terminal coupled to a gate driver circuit;
   a plurality of fly capacitors, each fly capacitor coupled between at least one phase switch and series switch;
   a first set of voltage regulators, each configured to drive one of the gate driver circuits coupled to one of the phase switches, and each configured to draw a supply voltage from either a series-side terminal of at least one of the fly capacitors or a step-up converter input terminal; and
   a second set of voltage regulators, each configured to drive one of the gate driver circuits coupled to one of the series switches, and each configured to draw a supply voltage from either a series-side terminal of at least one of the fly capacitors or a step-up converter output terminal;
wherein the charge pump circuit is configured to:
   receive an input voltage at the step-up converter input terminal, without operating the phase switches or the series switches;
   determine that the supply voltages for the first set of voltage regulators are sufficient to operate the phase switches in at least a reduced gate drive mode;
   operate the phase switches without operating the series switches, after determining that the supply voltages for the first set of voltage regulators are sufficient to operate the phase switches;
   determine that a voltage at the step-up converter output terminal exceeds a threshold voltage;
   not operate the phase switches and the series switches for a predetermined period of time, after determining that the voltage at the step-up converter output terminal exceeds the threshold voltage; and
   after the predetermined period of time, determine that the supply voltages for the second set of voltage regulators are sufficient to operate the series switches in at least a reduced gate drive mode, and
   operate both the phase switches and the series switches, after determining that the supply voltages for the second set of voltage regulators are sufficient to operate the series switches.
      2. The apparatus of clause 1, wherein determining that the supply voltages for the first set of voltage regulators are sufficient to operate the phase switches in at least the reduced gate drive mode comprises:
determining that the supply voltage for one of the first set of voltage regulators exceeds a sum of its drop-out voltage and a source voltage of its associated phase switch.
   3. The apparatus of clause 2, further comprising:
a comparator circuit configured to determine whether the supply voltage for one of the first set of voltage regulators exceeds the sum of its drop-out voltage and the source voltage of its associated phase switch.
   4. The apparatus of any of the preceding clauses, further comprising:
a bootstrapping capacitor or bootstrapping circuit configured to provide supply voltage to at least one of the first set of voltage regulators.
   5. The apparatus of clause 4, wherein the bootstrapping capacitor or the bootstrapping circuit is configured to provide supply voltage to at least one of the first set of voltage regulators from the step-up converter input terminal.
   6. The apparatus of any of the preceding clauses, wherein operating the phase switches without operating the series switches comprises operating the phase switches in the reduced gate drive mode.
   7. The apparatus of any of the preceding clauses,
wherein the phase switches are N-channel MOSFETs;
wherein the charge pump circuit further comprises a plurality of P-channel MOSFETs, each electrically coupled in parallel with a corresponding N-channel MOSFET phase switch; and
wherein operating the phase switches without operating the series switches comprises operating the P-channel MOSFETs using the supply voltages for the first set of voltage regulators drawn from the step-up converter input terminal.
   8. The apparatus of any of the preceding clauses, further comprising:
a comparator circuit configured to determine whether a voltage at the step-up converter output terminal exceeds a threshold voltage.
   9. The apparatus of any of the preceding clauses, wherein determining that the supply voltages for the second set of voltage regulators are sufficient to operate the series switches in at least a reduced gate drive mode comprises:
determining that the supply voltage for the one of the second set of voltage regulators exceeds a sum of its drop-out voltage and a source voltage of its associated series switch.
   10. The apparatus of any clause 9, further comprising:
a comparator circuit configured to determining whether the supply voltage for the one of the second set of voltage regulators exceeds the sum of its drop-out voltage and the source voltage of its associated series switch.
   11. The apparatus of any of the preceding clauses, further comprising:
a bootstrapping capacitor or bootstrapping circuit configured to provide supply voltage to at least one of the second set of voltage regulators.
   12. The apparatus of clause 11, wherein the bootstrapping capacitor or the bootstrapping circuit configured to provide supply voltage to at least one of the second set of voltage regulators from the step-up converter output terminal.
   13. The apparatus of any of the preceding clauses, wherein operating both the phase switches and the series switches comprises operating both the phase switches and the series switches in the reduced gate drive mode.
   14. The apparatus of any of the preceding clauses, wherein the charge pump circuit is further capable of operating as a step-down converter after it has been powered up.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is also intended that the sequence of steps shown in figures are only for illustrative purposes and are not intended to be limited to any particular sequence of steps. As such, those skilled in the art can appreciate that these steps can be performed in a different order while implementing the same method.

It is appreciated that certain features of the specification, which are, for clarity, described in the context of separate embodiments, may also be provided in combination in a single embodiment. Conversely, various features of the specification, which are, for brevity, described in the context of a single embodiment, may also be provided separately or in any suitable sub-combination or as suitable in any other described embodiments of the specification. Certain features described in the context of various embodiments are not to be considered essential features of those embodiments unless the embodiment is inoperative without those elements.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

Spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In this disclosure, the term “coupled” may also be termed as “electrically coupled”, and the term “connected” may be termed as “electrically connected”. “Coupled” and “connected” may also be used to indicate that two or more elements cooperate or interact with each other.

While embodiments of the present disclosure may address some challenges and provide some benefits, the stated problems and features herein are intended to be examples and not limit the claims or scope of this disclosure. Indeed, the disclosed embodiments may address challenges and provide benefits not explicitly enumerated.

1.-14. (canceled)

15. An integrated circuit, comprising:
a charge pump circuit capable of operating as a step-up converter and including:
a plurality of phase switches and series switches, each of the switches including a gate terminal coupled to a gate driver circuit, wherein the phase switches and series switches are configured to couple to a plurality of fly capacitors, each fly capacitor configured to couple between at least one phase switch and series switch;
a first set of voltage regulators, each configured to drive one of the gate driver circuits coupled to one of the phase switches, and each configured to draw a supply voltage from either a series-side terminal of at least one of the fly capacitors or a step-up converter input terminal; and
a second set of voltage regulators, each configured to drive one of the gate driver circuits coupled to one of the series switches, and each configured to draw a supply voltage from either a series-side terminal of at least one of the fly capacitors or a step-up converter output terminal;
wherein the charge pump circuit is configured to:
receive an input voltage at the step-up converter input terminal, without operating the phase switches or the series switches,
determine that the supply voltages for the first set of voltage regulators are sufficient to operate the phase switches in at least a reduced gate drive mode,
operate the phase switches, without operating the series switches, after determining that the supply voltages for the first set of voltage regulators are sufficient to operate the phase switches,
determine that the supply voltage for one of the second set of voltage regulators is sufficient to operate its corresponding series switch in at least a reduced gate drive mode, and
operate the corresponding series switch, after determining that the supply voltage for the one of the second set of voltage regulators is sufficient to operate the corresponding series switch.

16. The integrated circuit of claim 15, wherein determining that the supply voltages for the first set of voltage regulators are sufficient to operate the phase switches in at least the reduced gate drive mode comprises:
determining that the supply voltage for one of the first set of voltage regulators exceeds a sum of its drop-out voltage and a source voltage of its associated phase switch.

17. The integrated circuit of claim 16, further comprising:
a comparator circuit configured to determine whether the supply voltage for one of the first set of voltage regulators exceeds the sum of its drop-out voltage and the source voltage of its associated phase switch.

18. The integrated circuit of claim 15, further comprising:
a bootstrapping capacitor or bootstrapping circuit configured to provide supply voltage to at least one of the first set of voltage regulators.

19. The integrated circuit of claim 18, wherein the bootstrapping capacitor or the bootstrapping circuit is configured to provide supply voltage to at least one of the first set of voltage regulators from the step-up converter input terminal.

20. The integrated circuit of claim 15, wherein operating the phase switches without operating the series switches comprises operating the phase switches in the reduced gate drive mode.

21. The integrated circuit of claim 15,
wherein the phase switches are N-channel MOSFETs;
wherein the charge pump circuit further includes a plurality of P-channel MOSFETs, each electrically coupled in parallel with a corresponding N-channel MOSFET phase switch; and
wherein operating the phase switches without operating the series switches comprises operating the P-channel MOSFETs using the supply voltages for the first set of voltage regulators drawn from the step-up converter input terminal.

22. The integrated circuit of claim 15, wherein determining that the supply voltage for the one of the second set of voltage regulators is sufficient to operate its corresponding series switch in at least the reduced gate drive mode comprises:
determining that the supply voltage for the one of the second set of voltage regulators exceeds a sum of its drop-out voltage and a source voltage of its associated series switch.

23. The integrated circuit of claim 22, further comprising:
a comparator circuit configured to determine whether the supply voltage for the one of the second set of voltage regulators exceeds the sum of its drop-out voltage and the source voltage of its associated series switch.

24. The integrated circuit of claim 15, further comprising:
a bootstrapping capacitor or bootstrapping circuit configured to provide supply voltage to at least one of the second set of voltage regulators.

25. The integrated circuit of claim 24, wherein the bootstrapping capacitor or the bootstrapping circuit is configured to provide supply voltage to at least one of the second set of voltage regulators from the step-up converter output terminal.

26. The integrated circuit of claim 15, wherein operating the corresponding series switch comprises operating the corresponding series switch in the reduced gate drive mode.

27. The integrated circuit of claim 15, wherein the charge pump circuit is further configured to:
determine that the supply voltages for a first subset of the second set of voltage regulators are sufficient to operate their corresponding series switches in at least a reduced gate drive mode;
determine that the supply voltages for a second subset of the second set of voltage regulators are insufficient to operate their corresponding series switches in at least a reduced gate drive mode; and
operate the series switches corresponding to the first subset of the second set of voltage regulators while not operating the series switches corresponding to the second subset of the second set of voltage regulators.

28. The integrated circuit of claim 15, wherein the charge pump circuit is further capable of operating as a step-down converter after it has been powered up.

29. A power converter apparatus, comprising:
a charge pump circuit capable of operating as a step-up converter and including:
a plurality of phase switches and series switches, each of the switches including a gate terminal coupled to a gate driver circuit;
a plurality of fly capacitors, each fly capacitor coupled between at least one phase switch and series switch;
a first set of voltage regulators, each configured to drive one of the gate driver circuits coupled to one of the phase switches, and each configured to draw a supply voltage from either a series-side terminal of at least one of the fly capacitors or a step-up converter input terminal; and
a second set of voltage regulators, each configured to drive one of the gate driver circuits coupled to one of the series switches, and each configured to draw a supply voltage from either a series-side terminal of at least one of the fly capacitors or a step-up converter output terminal;
wherein the charge pump circuit is configured to:
receive an input voltage at the step-up converter input terminal, without operating the phase switches or the series switches,
determine that the supply voltages for the first set of voltage regulators are sufficient to operate the phase switches in at least a reduced gate drive mode,
operate the phase switches, without operating the series switches, after determining that the supply voltages for the first set of voltage regulators are sufficient to operate the phase switches,
determine that the supply voltage for one of the second set of voltage regulators is sufficient to operate its corresponding series switch in at least a reduced gate drive mode, and
operate the corresponding series switch, after determining that the supply voltage for the one of the second set of voltage regulators is sufficient to operate the corresponding series switch.

30. The apparatus of claim 29, wherein determining that the supply voltages for the first set of voltage regulators are sufficient to operate the phase switches in at least the reduced gate drive mode comprises:
determining that the supply voltage for one of the first set of voltage regulators exceeds a sum of its drop-out voltage and a source voltage of its associated phase switch.

31. The apparatus of claim 30, further comprising:
a comparator circuit configured to determine whether the supply voltage for one of the first set of voltage regulators exceeds the sum of its drop-out voltage and the source voltage of its associated phase switch.

32. The apparatus of claim 29, further comprising:
a bootstrapping capacitor or bootstrapping circuit configured to provide supply voltage to at least one of the first set of voltage regulators.

33. The apparatus of claim 32, wherein the bootstrapping capacitor or the bootstrapping circuit is configured to provide supply voltage to at least one of the first set of voltage regulators from the step-up converter input terminal.

34. The apparatus of claim 29, wherein operating the phase switches without operating the series switches comprises operating the phase switches in the reduced gate drive mode.

35. The apparatus of claim 29,
wherein the phase switches are N-channel MOSFETs;
wherein the charge pump circuit further includes a plurality of P-channel MOSFETs, each electrically coupled in parallel with a corresponding N-channel MOSFET phase switch; and
wherein operating the phase switches without operating the series switches comprises operating the P-channel MOSFETs using the supply voltages for the first set of voltage regulators drawn from the step-up converter input terminal.

36. The apparatus of claim 29, wherein determining that the supply voltage for the one of the second set of voltage regulators is sufficient to operate its corresponding series switch in at least the reduced gate drive mode comprises:
determining that the supply voltage for the one of the second set of voltage regulators exceeds a sum of its drop-out voltage and a source voltage of its associated series switch.

37. The apparatus of claim 36, further comprising:
a comparator circuit configured to determine whether the supply voltage for the one of the second set of voltage regulators exceeds the sum of its drop-out voltage and the source voltage of its associated series switch.

38. The apparatus of claim 29, further comprising:
a bootstrapping capacitor or bootstrapping circuit configured to provide supply voltage to at least one of the second set of voltage regulators.

39. The apparatus of claim 38, wherein the bootstrapping capacitor or the bootstrapping circuit is configured to provide supply voltage to at least one of the second set of voltage regulators from the step-up converter output terminal.

40. The apparatus of claim 29, wherein operating the corresponding series switch comprises operating the corresponding series switch in the reduced gate drive mode.

41. The apparatus of claim 29, wherein the charge pump circuit is further configured to:
determine that the supply voltages for a first subset of the second set of voltage regulators are sufficient to operate their corresponding series switches in at least a reduced gate drive mode;
determine that the supply voltages for a second subset of the second set of voltage regulators are insufficient to operate their corresponding series switches in at least a reduced gate drive mode; and
operate the series switches corresponding to the first subset of the second set of voltage regulators while not operating the series switches corresponding to the second subset of the second set of voltage regulators.

42. The apparatus of claim 29, wherein the charge pump circuit is further capable of operating as a step-down converter after it has been powered up.

43.-84. (canceled)
